(19) United States
(12) Patent Application Publication
(10) Pub. No.: US 2023/0300801 A1
(43) Pub. Date: Sep. 21, 2023

(54) PROCEDURES FOR INTRA-BAND COEXISTENCE BETWEEN NR V2X AND LTE V2X

(71) Applicant: Samsung Electronics Co., Ltd., Gyeonggi-do (KR)

(72) Inventors: Yaser Mohamed Mostafa Kamal FOUAD, San Diego, CA (US); Philippe Jean Marc Michel SARTORI, Naperville, IL (US)

(21) Appl. No.: 18/101,175

(22) Filed: Jan. 25, 2023

Related U.S. Application Data
(60) Provisional application No. 63/321,970, filed on Mar. 21, 2022.
(60) Provisional application No. 63/335,062, filed on Apr. 26, 2022.

(51) Int. Cl. H04W 72/02; H04W 72/54; H04W 72/0446

(52) U.S. Cl. CPC H04W 72/02; H04W 72/54; H04W 72/0446

(57) ABSTRACT

Systems and methods are disclosed for transmission by a UE in a coexistence band of a first communication scheme and a second communication scheme. A method includes identifying that the UE is operating on a shared carrier; determining whether a beginning of a first communication scheme slot coincides with a beginning of a second communication scheme subframe on the shared carrier; in response to determining that the beginning of the first communication scheme slot coincides with the beginning of the second communication scheme subframe, performing energy detection; and performing a first type of slot transmission based on energy detected for an overlapping subframe of the second communication scheme subframe being less than a first threshold.

### CROSS-REFERENCE TO RELATED APPLICATIONS

This application claims the priority benefit under 35 U.S.C. § 119(e) to U.S. Provisional Application Nos. 63/321,970 and 63/335,062, filed on Mar. 21, 2022, and Apr. 26, 2022, respectively, the disclosure of each of which is incorporated by reference in its entirety as if fully set forth herein.

### TECHNICAL FIELD

The disclosure generally relates to long term evolution (LTE) vehicle to everything (V2X) and new radio (NR) V2X coexistence. More particularly, the subject matter disclosed herein relates to improvements to power saving and resource selection for intra-band coexistence between NR V2X and LTE V2X.

### SUMMARY

LTE V2X is expected to play a role in enabling the exchange of basic safety messages (BSMs) between neighboring vehicles. However, LTE V2X lacks the ability to support higher data traffic rates, thus limiting its applications.

In addition, the LTE V2X spectrum may be underutilized due to the limited number of BSMs.

A possible approach to resolve these issues is to allow NR V2X to harvest the remaining unutilized LTE V2X spectrum and to coexist on the same carrier. This is unlike the in-device coexistence of Rel-16, in which a user equipment (UE) performs prioritization between LTE and NR sidelinks (SLs) on different carriers in a time division multiplexing (TDM) manner.

In case of co-channel coexistence between LTE and NR SLs on the same carrier, NR procedures must be carefully designed so as not to affect performance of LTE V2X. In particular, NR devices should be able to detect periodic LTE traffic and newly incoming LTE traffic, and accordingly, avoid their resource reservations.

In addition, NR procedures should be able to adapt Mode 2 resource selection mechanisms to avoid potential collisions when reservations are overridden by LTE devices and when the number of available resources for NR is limited and/or located far apart from one another.

Further, for legacy reasons, coexistence should be possible with an LTE device being unaware that the carrier is being shared.

To overcome these issues, systems and methods are described herein for improving the coexistence of LTE and NR devices without significantly impacting reliability of LTE transmissions by providing techniques to allow for the application of NR Rel-17 resource selection assistance schemes in case of coexistence.

More specifically, systems and methods are described herein, wherein the behaviors of assisted and assisting UEs are updated to reduce the chances of collisions between NR and LTE UEs.

Systems and methods are also described herein for coexistence between NR Mode 1 UEs and LTE Modes 3 and 4.

Systems and methods are also described herein, which provide priority and occupancy constraints to enable/disable coexistence between NR and LTE UEs.

Systems and methods are also described herein, which allow power saving UEs to utilize a coexistence band while minimizing their impact on the LTE UEs.

Systems and methods are also described herein, wherein constraints are introduced in cases wherein an LTE subframe overlaps with multiple NR slots, in order to reduce the interference incurred by LTE UEs due to the presence of NR UEs.

Systems and methods are also described herein, which allow for the operation of power saving UEs with discontinuous reception (DRX) enabled in the coexistence band while minimizing their impact on LTE UEs.

Systems and methods are also described herein, which reduce the number of possible periods when operating in the coexistence band in order to reduce chances of consistent collisions between neighboring NR and LTE UEs.

The above approaches also improve on previous methods because they allow NR V2X UEs to access the LTE V2X spectrum with minimal impact on LTE V2X UEs due to collisions from NR V2X UE, and allow NR V2X UEs to utilize resource selection assistance schemes of NR Rel-17 while operating in the coexistence band.

The above approaches also introduce new rules when selecting/applying the preferred/non-preferred resource selection sets in the coexistence band in order to minimize their impact on LTE transmissions, allows the coexistence of the centralized NR Mode 1 resource selection scheme with the resource selection schemes of LTE (i.e., Mode 3 and Mode 4) by enabling NR V2X UEs to feedback their detected LTE reservations to a gNB, and reduces the impact of low priority NR SL transmissions on those of LTE V2X UE by introducing priority and occupancy based thresholds for accessing the coexistence band.

The above approaches also allow power saving NR V2X UEs to detect LTE reservations and accordingly coexist with LTE V2X UEs in the coexistence band, allow NR V2X UEs to operate with higher subcarrier spacing (SCS) in the coexistence band while minimizing their impact on LTE V2X UEs, and provide sensing rules for power saving V2X UEs with DRX enabled to detect and avoid LTE reservations when operating in the coexistence band.

The above approaches also reduce the chances of consistent collisions between LTE and NR V2X UEs in the coexistence band by reducing the set of possible periods that can be used by NR V2X UEs when operating in the coexistence band.

In an embodiment, a method of transmission performed by a UE in a coexistence band of a first communication scheme and a second communication scheme is provided. The method includes identifying that the UE is operating on a shared carrier; determining whether a beginning of a first communication scheme slot coincides with a beginning of a second communication scheme subframe on the shared carrier; in response to determining that the beginning of the first communication scheme slot coincides with the beginning of the second communication scheme subframe, performing energy detection; and performing a first type of slot transmission based on energy detected for an overlapping subframe of the second communication scheme subframe being less than a first threshold.

In an embodiment, a UE to perform transmission in a coexistence band of a first communication scheme and a second communication scheme is provided. The UE includes a transceiver; and a processor configured to identify that the UE is operating on a shared carrier; determine whether a beginning of a first communication scheme slot coincides with a beginning of a second communication scheme subframe on the shared carrier; in response to determining that the beginning of the first communication scheme slot coincides with the beginning of the second communication scheme subframe, perform energy detection; and perform a first type of slot transmission based on energy detected for an overlapping subframe of the second communication scheme subframe being less than a first threshold,

In an embodiment, a method of transmission performed by a UE in a coexistence band of a first communication scheme and a second communication scheme is provided. The method includes receiving, from an assisting UE, resource assistance information, wherein the resource assistance information is determined by the assisting UE based on a first communication scheme resource pool and a coexistence resource pool; and selecting a resource for transmission based on the received assistance information and sensing information of the first and second communication schemes.

### BRIEF DESCRIPTION OF THE DRAWINGS

In the following section, the aspects of the subject matter disclosed herein will be described with reference to exemplary embodiments illustrated in the figures, in which:

FIG. 1 illustrates an example of energy detection before transmission in a coexistence band by NR UEs;

FIG. 2 is a flowchart illustrating Mode 4 sensing and resource selection procedures;

FIG. 3 is a flowchart illustrating Mode 2 sensing and resource selection procedures;

FIG. 4 illustrates an example of dynamic coexistence between LTE and NR transmissions, according to an embodiment;

FIG. 5 illustrates selection of assistance information from NR and coexistence pools according to an embodiment;

FIG. 6 illustrates an NR UE with no LTE modem relying on assistance information for selecting resources in an NR pool that partially or fully overlaps with an LTE pool according to an embodiment;

FIG. 7 illustrates Mode 4 LTE UEs coexisting with NR Mode 1 UEs, according to an embodiment;

FIG. 8 illustrates a type A slot, according to an embodiment;

FIG. 9 illustrates a type B slot, according to an embodiment;

FIG. 10 illustrates a mapping of type A slots and type B slots, according to an embodiment;

FIG. 11 is flowchart illustrating a UE transmission operation, according to an embodiment;

FIG. 12 is a flowchart illustrating an NR UE operation on a shared carrier, according to an embodiment;

FIG. 13 illustrates an example of a limit on a maximum number transmissions by an NR UE per LTE subframe in a coexistence pool, according to an embodiment;

FIG. 14 illustrates an example of a limit on a maximum number of NR UEs that can transmit per LTE subframe in a coexistence pool, according to an embodiment;

FIG. 15 illustrates a restriction on possible NR periods in a coexistence band, according to an embodiment; and

FIG. 16 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Although various embodiment of the disclosure are described below with reference to LTE and NR as different communication schemes of a coexistence band, the present disclosure is not limited to these specific communications schemes and may be applied to other communication schemes having similar features and configurations.

LTE V2X was standardized in order to allow communication between nearby vehicles. LTE V2X communication links allow vehicles to exchange BSMs to avoid potential accidents or to enhance the user experience by sharing real-time road characteristics (e.g., traffic).

However, as LTE V2X was mostly designed for periodic traffic, it offers limited data rates, and is designed only for broadcasting messages. To address these limitations, NR Rel-16 V2X was developed to offer support for aperiodic traffic and data rate enhancements to offer support for a wider variety of applications. Subsequently, NR Rel-16 and Rel-17 are expected to operate concurrently with LTE V2X on a separate band to widen the range of supported V2X applications.

Operating NR and LTE independently is possible, but suboptimal. In particular, given the nature of BSMs, the LTE V2X spectrum is not expected to be fully occupied at any given instance.

Coexistence of NR SL and LTE SL on the same carrier is currently being investigated by the 3^{rd} generation partnership project (3GPP).

Given the nature and importance of BSMs carried by LTE, it is important that the performance of LTE is not significantly affected by NR. In addition, LTE V2X should be able to operate without being aware of the NR V2X operation on the same carrier to maintain backward compatibility.

In accordance with aspect of the disclosure, techniques/procedures are provided for the coexistence of LTE and NR devices, without significantly impacting the reliability of LTE transmissions, by extending procedures defined for an NR carrier to a shared LTE-NR carrier.

Rel-16 NR/LTE In-Device Coexistence

In Rel-16, LTE and NR in-device coexistence is supported when LTE and NR are deployed on different carriers. In particular, a UE is assumed to have LTE and NR capabilities, wherein there is subframe boundary alignment between LTE and NR V2X SLs, and both LTE and NR V2X SLs are aware of a time resource index (e.g., a direct frame number (DFN) for LTE) in both carriers.

In addition, there may be short term TDM coexistence between the LTE and NR SLs on different carriers. In particular, the following was considered in case of transmission (Tx)/Tx, reception (Rx)/Rx, and Tx/Rx overlap between the two SLs:

For Tx/Tx overlap, if packet priorities of the LTE and NR SL transmissions are known to both radio access technologies (RATs) prior to time of transmission subject to processing time restrictions, then the packet with a higher relative priority is transmitted. In case the priorities of LTE and NR SL transmissions are the same, it is up to UE implementation as to which transmission is chosen (e.g., taking into account congestion and/or other factors). If packet priorities of both LTE and NR SL transmissions are not known to both RATs prior to time of transmission subject to processing time restriction, it is up to UE implementation to manage Tx/Tx overlaps (e.g., LTE transmissions are always prioritized, etc.).

For Rx/Rx overlap, it is up to UE implementation to manage reception of LTE and NR SLs.

For Tx/Rx overlap, if packet priorities of the LTE and NR SLs are known to both RATs prior to time of transmission/reception subject to processing time restrictions, then a packet with a higher relative priority is transmitted/received. In case the priorities of LTE and NR SL packets are the same, then it is up to UE implementation as to which packet is transmitted/received.

However, these techniques do not offer any flexibility in using unutilized LTE resources by an NR SL. Instead, they apply only for NR and LTE deployed on different carriers, whereas the scope in Rel-18 is now expanded to NR and LTE sharing the same carrier. In addition, the UE is limited to performing prioritization between the LTE and NR SL transmissions on different carriers (i.e., short-term TDM between the LTE and NR SLs based on priority). In addition, this prioritization is also restricted to processing time restrictions, which can be as high as 4 ms, as agreed in RAN1 #102.

Intra-Band Coexistence Between NR V2X and LTE V2X

To avoid the impact of NR UEs on LTE UEs in coexistence band, one possibility is to rely on energy detection. For example, an energy-detection based avoidance mechanism may be used by NR devices to detect LTE reservations and accordingly avoid them. In particular, an NR device can perform energy detection on one or more symbols at the beginning of each subframe and accordingly decide whether to access this resource or not.

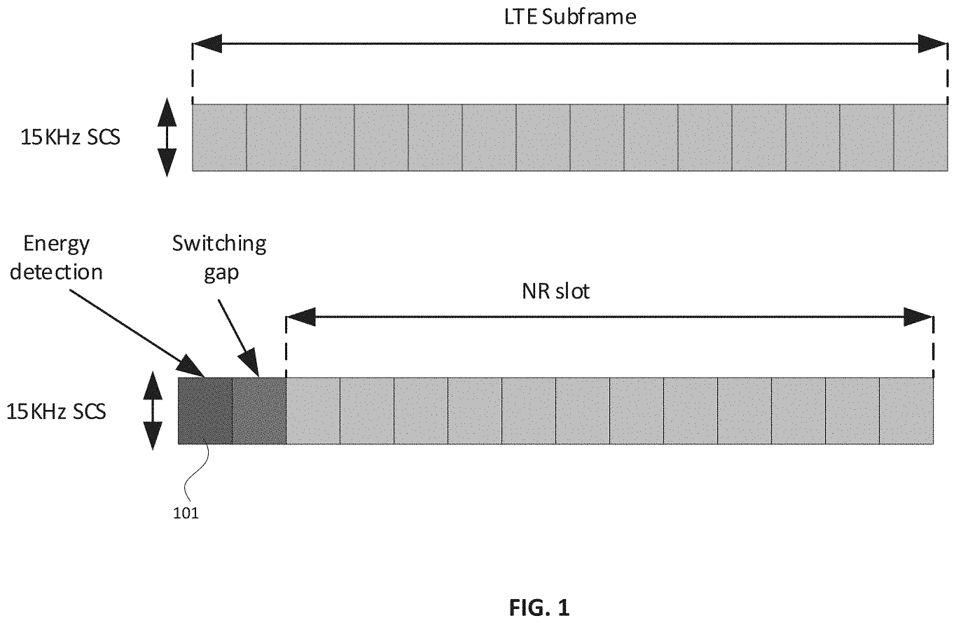

FIG. 1 illustrates an example of energy detection before transmission in a coexistence band by NR UEs.

Referring to FIG. 1, an NR device performs sensing in a first symbol 101, then switches and performs NR transmission for the remainder of the subframe (i.e., the remaining 12 orthogonal frequency-division multiplexing (OFDM) symbols in case of 15 KHz SCS).

The sensing, as illustrated in FIG. 1, can be used to enable further protection to LTE devices when considered in addition to the detected periodic reservations by LTE. This may help in reducing the chances of collisions with LTE aperiodic-like traffic (i.e., the beginning of the periodic reservations by LTE) and periodic traffic in case of the absence of an LTE modem in the NR UE. Alternatively, it can also be used to achieve better utilization by reusing the resources blocked by the LTE periodic reservations if no energy is detected.

Resource Selection Assistance Schemes 1 and 2 of NR Rel-17 SL

In NR Rel-17, two resource selection assistance schemes have been developed for SL transmissions. An objective of these schemes is to resolve conflicts due to a half-duplex constraint, a hidden node problem, and consistent collisions.

In the first scheme (i.e., scheme 1), an assisting UE (referred to as UE-A) provides a set of preferred or non-preferred resources to an assisted UE (referred to as UE-B). This can be done based on UE-A receiving an explicit request for resource selection assistance from the UE-B or based on a pre-configured triggering condition. To obtain the set of preferred or non-preferred resources, the UE-A executes the Mode 2 resource selection scheme to identify resources reserved by neighboring UEs. This may increase the effective sensing range of UE-B, helping to resolve the hidden node problem. In addition, the UE-A also considers the set of reserved resources for its future transmissions when performing the resource selection, which may reduce the impact of the half-duplex constraint on the performance.

Once the resource selection assistance set is acquired at the UE-A, it may transmit this set to the UE-B within a given time constraint. When the UE-B receives the set of resources, two cases can be considered:
1) When the UE-B performs sensing for resource selection, it considers both the received resource selection assistance set and its own sensing results when performing resource selection. In particular, when a non-preferred resource set is received, these resources may be excluded from the resources obtained after performing sensing and before the final selection by the MAC layer. However, when a preferred resource set is received, the UE-B obtains an intersection set between the sensed resources and the received preferred resource set and then passes this intersection set to the MAC layer for resource selection.
2) When the UE-B does not perform sensing, then it uses only the received preferred resource set and passes this set to the MAC layer for resource selection.

When sending the resource selection assistance set, the UE-A should occupy at least one subchannel over one slot. In addition, the UE-A should perform sensing to find the resources to transmit its assistance report. In case the assistance is performed based on a request from the UE-B, the UE-A should also reserve resources and perform a transmission that carries the resource selection assistance request. Consequently, Scheme 1 may result in high latency and resource consumption; especially when the UE-B is transmitting a short packet with tight latency constraints.

In the second scheme (i.e., scheme 2), UE-A uses physical SL feedback channel (PSFCH) resources to provide a conflict indication to the UE-B. In particular, when the UE-B sends SL control information (SCI) that includes a reservation of a future resource and the UE-A detects that this resource reservation conflicts with another reservation from a neighboring UE, then it uses the PSFCH to send a conflict indication to the UE-B. Subsequently, the UE-B performs resource reselection to obtain a non-conflicting resources for its future transmission.

Resource Selection Procedures for LTE V2X UEs

Mode 3

Mode 3 is for resource allocation scheduled by an eNB. The eNB scheduling activity is driven by a UE needing to send data on a SL, and performing an SL buffer status reporting (BSR) procedure similar to that on a Uu in order to request an SL resource allocation from the eNB. Depending on a type of traffic the UE has to send, the eNB can provide a dynamic SL grant or an activation of a semi-persistent scheduling (SPS) SL grant.

Dynamic DL grant downlink control information (DCI) provides resources for up to two transmissions of the same transport block (TB), which allows higher reliability to be achieved without a feedback-based hybrid automatic repeat request (HARQ) procedure, since an LTE-V2X physical layer supports only broadcast transmission. Unlike Uu UL grants, modulation and coding scheme (MCS) information can optionally be provided by radio resource control (RRC) signaling instead of traditional DCI. When the RRC does not provide the MCS, a transmitting UE should select an appropriate MCS/transport block size (TBS) itself, based on the knowledge it has of the TB to be transmitted and, potentially, the SL radio conditions. The transmitting UE may populate its SCI with the information from eNB and other fields related to the SL operation, and then transmit the SCI and an associated physical SL shared channel (PSSCH).

The eNB can configured the UE with up to 8 SL SPS configurations, where each SL SPS configuration has an identifying index and provides a different periodicity of SL transmission resource. An SL SPS configuration is not used by the UE until the eNB sends the UE a DCI that indicates that the SL SPS configuration is now active. The activating DCI also provides the same fields as a dynamic SL scheduling DCI described above, allowing for precise resource allocation of SPS to be determined by the eNB. A transmitting UE can use the activated SL SPS resources, at the configured periodicity, until they are released (i.e., de-activated) by the eNB transmitting a special DCI. Each time the UE uses the resources, it either uses the RRC configured MCS/TBS or selects one itself, i.e., the same as a dynamic operation.

Mode 4

Mode 4 is for UE autonomous resource selection. Essentially, a UE senses, within a configured resource pool, which resources are not in use by other UEs with higher-priority traffic, and chooses an appropriate amount of such resources for its own physical SL control channel (PSCCH)/PSSCH transmission. Having selected the resources, the UE can transmit in them on a periodic (i.e., SPS) basis for a certain number of times, or until a cause of resource reselection is triggered.

The SCIs transmitted by UEs on PSCCHs indicate time-frequency resources in which the UEs will transmit a PSSCH. The same SCI content as used in Mode 3 is used in Mode 4, and also indicates the periodicity with which the UE will use the same resources. These SCI transmissions are used by sensing UEs to maintain a moving sensing window in the immediate past of which resources have been reserved by other UEs. For example, the moving sensing window is 1000 ms long for frequency division duplexing (FDD) systems. A sensing UE also measures the PSSCH-reference signal received power (RSRP) in the subframes of the sensing window, which implies the level of interference that would be caused and experienced if the sensing UE were to transmit in them.

The sensing UE then selects resources for its first transmission from within a resource selection window. This window may begin ≤4 ms after the trigger for transmission, and is bounded by the latency requirement of the traffic, up to 100 ms. The sensing UE assumes the same resources will be used by other UEs in the future as have been found reserved during the sensing window, according to the indicated periodicities and durations. Reserved resources in the selection window with a PSSCH-RSRP above a threshold are excluded from being candidates by the sensing UE, with the threshold being set according to the priorities of the traffic of the sensing and transmitting UE. Thus, a higher priority transmission from a sensing UE can occupy resources that are reserved by a transmitting UE with a relatively lower PSSCH-RSRP and relatively lower-priority traffic.

From the set of resources in the selection window that have not been excluded, the sensing UE identifies those containing the lowest total received energy as a way to account for transmissions that were not found during decoding of the PSCCHs, and identifies resources totaling 20% of the available resources within the traffic's latency bound, including gradual relaxation of the PSSCH-RSRP exclusion thresholds in 3 dB steps, if necessary. The UE then selects a resource at random from the identified 20% and uses this resource semi-persistently for its transmissions.

There are a number of triggers for resource re-selection. The triggers may be designed to support high mobility, and ensure that a UE cannot assume occupation of a resource for an excessive period, nor when the selected resource is either insufficient or excessive for what is needed by the UE's traffic, amongst other causes.

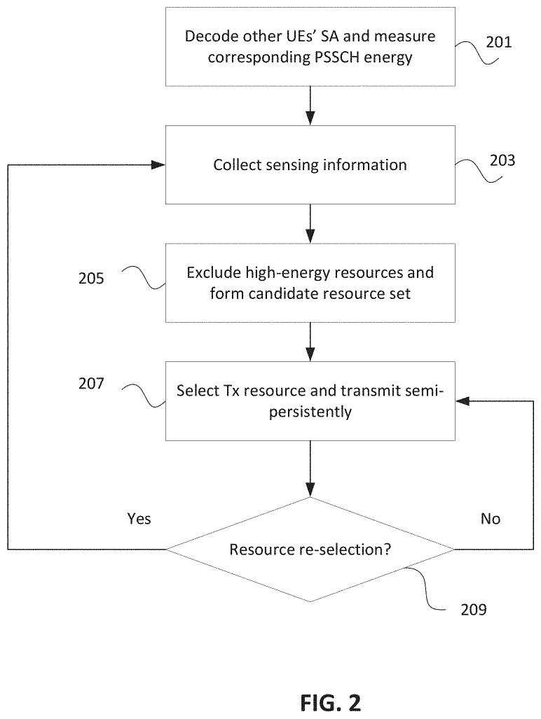

FIG. 2 is a flowchart illustrating Mode 4 sensing and resource selection procedures.

Referring to FIG. 2, in step 201, the sensing UE decodes other UEs' scheduling assignments (SAs) and measures the corresponding PSSCH energy.

In step 203, the sensing UE collects sensing information including PSSCH-RSRP and SL received signal strength indicator (S-RSSI) measurements.

In step 205, the sensing UE excludes high-energy resources and forms a candidate resource set. As described above, reserved resources in the selection window with a PSSCH-RSRP above a threshold are excluded from being candidates by the sensing UE, such that a higher priority transmission from the sensing UE can occupy resources that are reserved by a transmitting UE with a relatively lower PSSCH-RSRP and relatively lower-priority traffic.

In step 207, the sensing UE selects a resource for transmission from the candidate resource set and uses this resource semi-persistently for its transmissions.

In step 209, the sensing UE determines if resource-reselection should be performed. As described above, there may be a number of triggers for determining resource re-selection.

When the sensing UE determines to perform resource selection in step 209, the process returns to step 203, at which the sensing UE collects sensing information again. However, when the sensing UE determines not to perform resource selection in step 209, i.e., resource-reselection is not triggered, the process returns to step 207, at which the sensing UE re-selects a resource for transmission from the candidate resource set and uses this resource semi-persistently for its transmissions.

Resource Selection Procedures for NR UEs

Mode 1

Mode 1 is for resource allocation by a gNB. The use cases intended for NR V2X can generate a diverse array of periodic and aperiodic message types. Therefore, resource allocation mode 1 provides dynamic grants of SL resources from a gNB, as well as grants of periodic SL resources configured semi-statically by RRC (referred to as “SL configured grants (CGs)”).

Dynamic SL grant DCI can provide resources for one or multiple transmissions of a TB, in order to control reliability. The transmission or transmissions can be subject to an SL HARQ procedure, if that operation is enabled.

A Type 1 CG is an SL CG that is configured once and is immediately used by a UE, until it is released by RRC signaling. The UE is allowed to continue using this type of SL CG when beam failure or physical layer problems occur in NR Uu, until a radio link failure (RLF) detection timer expires, before falling back to an exception resource pool.

A Type 2 CG is an SL CG that is configured once, but cannot be used until the gNB sends, to the UE, DCI indicating that it is now active. The Type 2 CG may be used until another DCI is received, which indicates deactivation.

The resources in both Type 1 and Type 2 CGs include a set of SL resources recurring with a periodicity that a gNB desires to match to characteristics of V2X traffic. Multiple CGs can be configured in order to allow for different services, traffic types, etc.

MCS information for dynamic grants and CGs can optionally be provided or constrained by RRC signaling, instead of DCI. RRC signaling can be used to configure an MCS used by a transmitting UE, or a range of MCSs. The MCS may also be left as not configured.

When the RRC signaling does not provide the exact MCS, the transmitting UE should select an appropriate MCS itself, based on the knowledge it has of the TB to be transmitted and, potentially, the SL radio conditions.

The gNB scheduling activity is driven by the UE reporting its SL traffic characteristics to the gNB, or by performing an SL BSR procedure similar to that on Uu in order to request an SL resource allocation from the gNB.

Mode 2

Mode 2 is for UE autonomous resource selection. In Mode 2, a UE senses, within a configured resource pool, which resources are not in use by other UEs with higher-priority traffic, and chooses an appropriate amount of such resources for its own transmissions. Having selected such resources, the UE can transmit and re-transmit using the selected resources a certain number of times, or until a resource reselection is triggered.

In the Mode 2 sensing procedure, a sensing UE can select and then reserve resources for a variety of purposes reflecting that NR V2X introduces SL HARQ in support of unicast and groupcast in the physical layer. The sensing UE may reserve resources to be used for a number of blind (re-)transmissions or HARQ-feedback-based (re-)transmissions of a TB, in which case the resources are indicated in SCI scheduling the TB. Alternatively, the sensing UE may select resources to be used for an initial transmission of a later TB, in which case the resources are indicated in SCI scheduling a current TB, in a manner similar to the LTE-V2X scheme. An initial transmission of a TB can be performed after sensing and resource selection, but without a reservation.

First-stage SCI transmitted by UEs on PSCCHs indicate time-frequency resources in which the UEs will transmit a PSSCH. These SCI transmissions are used by sensing UEs to maintain a record of which resources have been reserved by other UEs. When a resource selection is triggered (e.g., by traffic arrival or a re-selection trigger), the sensing UE considers a sensing window that starts a (pre-)configured time in the past and finishes shortly before the trigger time. For example, the window can be either 1100 ms or 100 ms wide, with the intention that the 100 ms option is particularly useful for aperiodic traffic, and 1100 ms particularly for periodic traffic. The sensing UE also measures an SL-RSRP in the slots of the sensing window, which implies the level of interference that would be caused and experienced if the sensing UE were to transmit in them. In NR-V2X, an SL-RSRP is a (pre-)configurable measurement of a PSSCH-RSRP or a PSCCH-RSRP.

The sensing UE then selects resources for its (re-)transmission(s) from within a resource selection window. The window starts shortly after the trigger for (re-)selection of resources, and cannot be longer than the remaining latency budget of the packet due to be transmitted. Reserved resources in the selection window with an SL-RSRP above a threshold are excluded from being candidates by the sensing UE, with the threshold being set according to priorities of traffic of the sensing and transmitting UEs. Thus, a higher priority transmission from a sensing UE can occupy resources which are reserved by a transmitting UE with a relatively lower SL-RSRP and relatively lower-priority traffic.

If the set of resources in the selection window that have not been excluded is less than a certain proportion of the available resources within the window, the SL-RSRP exclusion threshold may be relaxed in 3 dB steps. The proportion is set by (pre-)configuration to 20%, 35%, or 50% for each traffic priority.

The UE randomly selects an appropriate amount of resources from this non-excluded set. The resources selected are generally not periodic. For example, up to three resources can be indicated in each SCI transmission, and each resource may be independently located in time and frequency.

When the indicated resources are for semi-persistent transmission of another TB, the range of supported periodicities is expanded compared to LTE-V2X, in order to cover the broader set of envisioned use cases in NR-V2X.

Before transmitting in a reserved resource, a sensing UE re-evaluates the set of resources from which it can select, in order to check whether its intended transmission is still suitable, taking account of late-arriving SCI, which are typically caused by an aperiodic higher-priority service starting to transmit after the end of the original sensing window. If the reserved resources would not be part of the set for selection at this time (i.e., T3), then new resources are selected from the updated resource selection window. The cut-off time T3 should be long enough before transmission to allow the UE to perform the calculations relating to resource re-selection.

There may be a number of triggers for resource re-selection, several of which are similar to LTE-V2X. In addition, there is the possibility to configure a resource pool with a pre-emption function designed to help accommodate aperiodic SL traffic, so that a UE reselects all the resources it has already reserved in a particular slot if another nearby UE with higher priority indicates it will transmit in any of them, implying a high-priority aperiodic traffic arrival at the other UE, and the SL-RSRP is above the exclusion threshold. The application of pre-emption can apply between all priorities of data traffic, or only when the priority of the pre-empting traffic is higher than a threshold and higher than that of the pre-empted traffic. A UE does not need to consider the possibility of pre-emption later than time T3 before the particular slot containing the reserved resources.

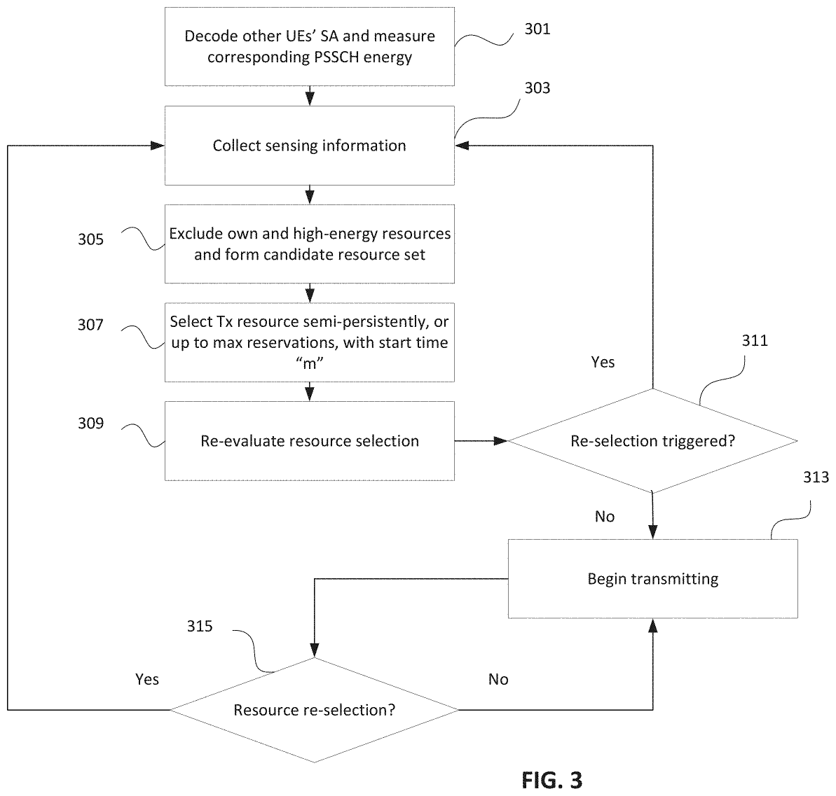

FIG. 3 is a flowchart illustrating Mode 2 sensing and resource selection procedures.

Referring to FIG. 3, in step 301, the sensing UE decodes other UEs' scheduling SAs and measures the corresponding PSSCH energy.

In step 303, the sensing UE collects sensing information including PSSCH-RSRP and S-RSSI measurements.

In step 305, the sensing UE excludes high-energy resources and forms a candidate resource set.

In step 307, the sensing UE selects a resource for transmission from the candidate resource set.

In step 309, the sensing UE re-evaluates the selected resource.

In step 311, the sensing UE determines whether re-selection is triggered, based on the re-evaluation. As described above, a sensing UE may re-evaluates the set of resources from which it can select, in order to check whether its intended transmission is still suitable, taking account of late-arriving SCI. If the reserved resources would not be part of the set for selection at this time (i.e., T3), then new resources are selected from the updated resource selection window.

When the sensing UE determines that re-selection is triggered in step 311, the process returns to step 303, at which the sensing UE collects sensing information again. However, when the sensing UE determines that re-selection is not triggered in step 311, the sensing UE starts transmitting using the selected resource.

In step 315, the sensing UE determines if resource-reselection should be performed. As described above, there may be a number of triggers for determining resource re-selection.

When the sensing UE determines to perform resource selection in step 315, the process returns to step 303, at which the sensing UE collects sensing information again. However, when the sensing UE determines not to perform resource selection in step 315, i.e., resource-reselection is not triggered, the process returns to step 312, at which the sensing UE continues transmitting using the selected resource in step 313.

As described above, semi-static coexistence can be configured between LTE and NR UEs to share resources. However, semi-static coexistence may jeopardize safety applications, is still somewhat inefficient, and cannot be location dependent.

More specifically, allocating a limited number of resources to LTE V2X UEs will result in increased collisions, thereby limiting the reliability of BSM transmissions.

Further, as semi-static partitioning does not adapt to traffic, it may result in either too many or too few resources being allocated for one system. Further, it is also difficult to re-configure LTE devices already deployed in the system.

Semi-static coexistence configuration cannot be location dependent because it should be pre-configured in order to enable out-of-coverage operation.

In view of the foregoing, there is a desire for dynamic coexistence between LTE V2X and NR SL. For example, the 5G automotive association (5GAA) has been pushing for this feature for a while.

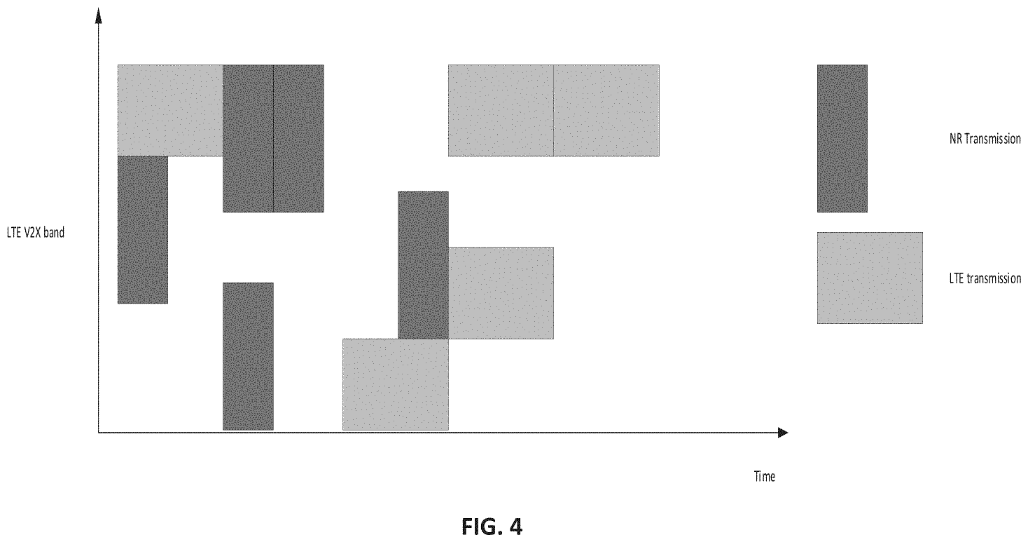

FIG. 4 illustrates an example of dynamic coexistence between LTE and NR transmissions, according to an embodiment.

Dynamic coexistence also allows for the efficient utilization of LTE V2X spectrum. To achieve this goal, NR V2X should harvest remaining, unutilized LTE V2X spectrum and coexist on the same carrier.

Herein, various procedures are provided to maximize gain from NR and LTE in-band coexistence, while minimizing the performance impact on LTE V2X UEs. In particular, the following are provided:
Modifications to the NR Rel-17 features (i.e., power saving and resource selection assistance) to make them applicable in coexistence band.
Constraints on NR UEs when operating in the coexistence band to limit the impact on the LTE V2X UEs.
DRX adaptation for NR UEs to enable coexistence.
Coexistence solutions between NR Mode 1 UEs and Modes 3 and 4 of LTE UEs.
Solutions for cases where the coexistence band is not wide enough to support NR transmissions with larger SCS.
Modification of the existing Mode 2 resource allocation procedure for NR UEs on a shared NR-LTE carrier.

Applicability of Rel-17 Resource Selection Schemes 1 and 2 with Coexistence

In NR Rel-17, two resource selection assistance schemes were developed to reduce the chances of collisions. For scheme 1, an assisting UE (i.e., UE-A) either selects a set of preferred or non-preferred resources to be passed to the assisted UE (i.e., UE-B). The final selection of the resources to use for transmission is done by considering sensing results, and the UE-A's scheduled transmissions (i.e., to avoid missing the transmission due to the half-duplex constraint).

Two options are provided:
Option 1. UE-A takes into account the fact that the carrier is a shared carrier (i.e., resources falling in coexistence band) when signaling the resources.
Option 2. UE-A passes resources ‘as is’ and UE-B determines whether to select the resources on the shared carrier.

UE-A Indicates Resources Including the Shared Carrier Aspect

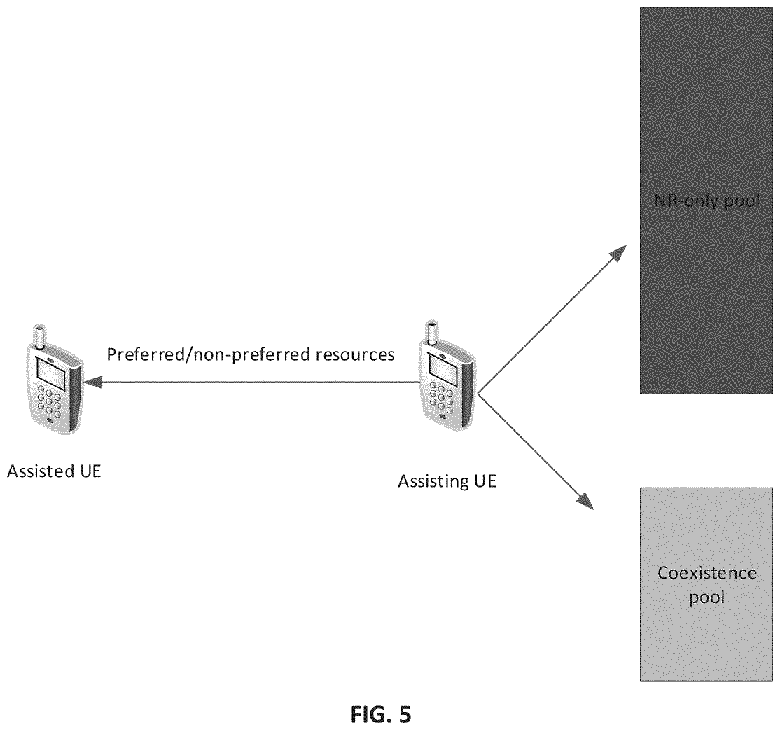

FIG. 5 illustrates selection of assistance information from NR and coexistence pools according to an embodiment.

To realize the gains from this assistance scheme, the UE-A should be able to select resources from dedicated NR resource pools as well as coexistence resource pools in which NR SL devices coexist with LTE V2X device, e.g., as illustrated in FIG. 5.

In addition, the UE-A should be able to monitor the carrier to detect periodic and aperiodic-like LTE traffic. In order to monitor the LTE carrier, the UE should know the LTE carrier configuration, and which carriers are available for sharing. This can be done by (pre-) configuration using RRC configuration to indicate the following:

List of LTE Carriers
Frequency span of each LTE carrier
Whether operation is Mode 3 or Mode 4 for this carrier
Whether this carrier can be shared with NR, and if yes, on which resources (e.g., some slots could be not shareable or a subset of the subchannels could be not sharable, whereas others could be). For example, a 1-bit field in a resource pool configuration can indicate whether this resource pool can be shared or not.
Parameters related to coexistence, e.g., priority limits, thresholds according to priority, etc.

UE-A is then expected to indicate that the selected resource pool for the assisted resource selection is either a dedicated NR resource pool or a shared one with LTE V2X. This can be done by one of the following:
UE-A indicates a specific resource pool, which is known to all UEs as a coexistence pool by its pre-configuration. That is, a parameter is provided in the resource pool configuration to indicate that the resource pool is a shared resource pool with LTE V2X devices; or
UE-A indicates in an assistance message that selected resources are subject to coexistence.

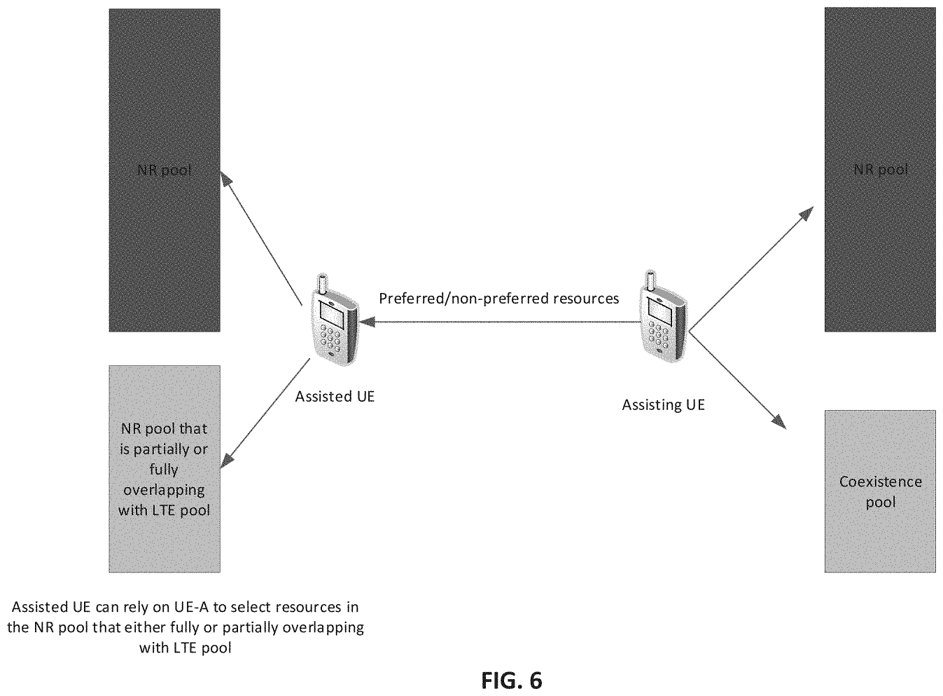

FIG. 6 illustrates an NR UE with no LTE modem relying on assistance information for selecting resources in an NR pool that partially or fully overlaps with an LTE pool according to an embodiment.

The indication can be done in 1st or 2nd stage SCI, as a MAC control element (CE), or by RRC configuration. For example, this is beneficial when only an assisting UE (i.e., UE-A) has an LTE modem and may need to provide an indication to an assisted UE (i.e., UE-B) that the resources are subject to coexistence along with the resource pool configuration via RRC signaling.

As another example, when an NR resource pool is configured in the coexistence band and a UE-B is expected to monitor only for NR traffic since it does not include an LTE modem, the UE-A can perform the measurements using its LTE modem over the coexistence band and provide the assistance information to the UE-B along with the indication of whether this is a coexistence resource pool or not (i.e., if the corresponding LTE resource pool is overlapping with the NR resource pool or not).

This type of indication is also helpful when the LTE resource pool configuration changes dynamically (e.g., a new pool is activated or deactivated), which might not be detectable by UE-B without an LTE modem.

When performing resource selection, the UE-A should treat the selected resources from the coexistence pool differently. More specifically, the UE-A, when selecting a preferred set, can prioritize the resource selection from NR pools before selecting from the coexistence pool. That is, because the resources used by NR UEs will cause interference to LTE UEs if they exist, resources from the coexistence pool may be deprioritized for future resource selection. Examples of treating the selected resources from the coexistence pool differently are provided below.

Different RSRP thresholds can be (pre-)configured for a coexistence pool for a Mode 2 resource selection. Typically, thresholds for a shared resource pool would be lower than those for an NR dedicated pool. These RSRP thresholds can be configured separately for each priority or an offset can be applied to all RSRP thresholds used for the NR dedicated. These configurations can be done by RRC signaling.
Existing RSRP thresholds for NR resource selection are defined by a pair of priorities for NR-NR traffic. Here, however, they are defined by NR-LTE pair. That is, if an NR UE has to transmit an NR packet with priority p, and if the UE measures an RSRP from a LTE packet transmitted with priority t, the threshold is dependent on both p and t. Accordingly, a set of RSRP thresholds can be pre-configured exclusively for the coexistence band that are a function of p and t.
A channel busy ratio (CBR) can also be used to determine if a carrier can be shared. If a UE-A measures a given CBR on the shared carrier, it determines whether resources can be shared (based on LTE and NR priorities as discussed above). For example, if the CBR is above a certain threshold, then the sharing can be disabled. This threshold determination can also be restricted to low-priority traffic only. In addition, the RSRP thresholds can also be dependent on priority.

In addition, the UE-A can rely on sensing information received by its LTE modem when selecting preferred resources, subject to processing time restrictions. More specifically, if an LTE modem detects that a future resource is reserved due to a periodic transmission and passes that to the NR modem, this reservation should be taken into consideration when selecting the preferred resources. Similarly, when selecting the non-preferred resources, a UE should deprioritize the ones from the coexistence pool because there is no guarantee that they will be accessible at time of transmission. This de-prioritization can also be done by considering different occupancy RSRP thresholds, similar to the case of preferred resources. In addition, the resources indicated as reserved by the LTE modem should be considered as non-preferred.

To utilize the resources in the coexistence band, the UE-B may be required to have an LTE modem in order to receive the LTE reservations or to have the ability to perform energy detection before transmitting. That is, the UE-B may need to indicate a capability of receiving an LTE SL, in order to be able to obtain resources on a shared carrier from UE-A. For example, the indication being capable of receiving an LTE SL may be done when requesting the assistance information by adding a 1-bit field to the request.

Alternatively, a UE-B which is not capable of receiving an LTE SL, can receive an indication from the UE-A that the assisted resources fall in a coexistence band, and accordingly, obtain resources on a shared carrier and only use them if it is capable of performing energy detection before transmission. For example, this may be applied when transmission of assistance information is triggered by a condition and not an explicit request.

UE Performs Weighting for the Shared Carrier Resources

In some cases, a UE-B may be required to use resources indicated by a UE-A. However, in some cases, the passed resources are ‘preferred/not preferred’ instead of ‘mandatory/not mandatory’. For example, this case may occur when the UE-B has its own sensing results and it will have to merge received assistance information with its own sensing results.

Once the resources are selected by the UE-A and passed to the UE-B, it is also expected that the UE-B will treat the resources in the coexistence pool in a different manner. Such resources (e.g., if they are preferred resources) can be deprioritized when performing the resource selection when compared to preferred resources from the dedicated NR resource pool. For example, two sets of resources (i.e., one in the coexistence band and another in the NR band) can be passed to the MAC layer, which can be instructed to select first from the preferred resource sets that does not fall in coexistence resource pool.

Similarly, if the received resources are non-preferred and fall in the coexistence pool then they should also be deprioritized when performing the resource exclusion. For example, the received resources in the coexistence pool can be excluded first, before the ones in the NR resource pool. This may be helpful in cases in which an over exclusion occurs and the UE-B should pass a specific number of resources to the higher layer for resource selection. For example, if the number of remaining resources, after the exclusion of non-preferred resources, is below a threshold, a UE can first attempt to include the non-preferred resources that are outside the coexistence resource pool in order to minimize the impact on LTE UEs.

Alternatively, the resources falling in the coexistence band can be restricted in the sense that they cannot be pulled back if the number of excluded resources is above a threshold, in order to minimize the impact on LTE UEs. The UE-B can also override assistance information received from the UE-A based on what it receives from its own LTE modem, if it is equipped with one. For example, even if the UE-B receives a preferred set, some of the elements within the preferred set can still be excluded if an indication is received from an LTE modem in the UE-B that these resources are reserved.

Further, a different set of channel occupancy ratio (CR)_limits can be configured for the coexistence resource pool in order to limit the number of resources that can be used by a UE in a given duration. Here, differences here compared to NR and LTE CR_limits include the following.
The CR_limit can be dependent on the resource pool. That is, two CR_limits can be configured for each UE, whereby one is aimed for an NR band and the other is aimed for the coexistence band. In such a case, the measurements for calculating the CBR and the counted number of transmissions can be done separately for each pool (e.g., by pre-configuration). Alternatively, the transmissions done in the NR band can also count towards the CR_limit of the coexistence band. Here, the CR_limit of the coexistence band will be implicitly impacted by transmissions of NR and LTE UEs since they will result in increasing the measured CBR in the coexistence band.
One CR_limit for a coexistence band and the NR band combined. In this case, the measurements and reserved resources by the NR UE will be done in the NR band and the coexistence band. For example, if a UE performs a large number of reservations in a given duration in the NR band (i.e., the UE reaches its CR_limit) then it can also be prevented from accessing the coexistence band.

In accordance with the above-described embodiments, an assisting NR device (i.e., a UE-A) considers both the coexistence pool and the NR resource pool when performing the selection for the resource selection assistance Scheme 1. That is, the NR UE may obtain the LTE carrier configuration from its LTE modem and consider the coexistence band for resource selection.

In accordance with the above-described embodiments, the UE-A can select preferred/non-preferred resource set based on the reservations received by its LTE modem if the indication is received in a timely manner, i.e., subject to a processing time requirement of an intra-UE coordination message.

In accordance with the above-described embodiments, the selection of preferred/non-preferred resources from the coexistence pool may be treated differently from those in the NR resource pools by 1) configuring different RSRP thresholds for a coexistence pool that are based on the LTE and NR priorities, 2) configuring different CBR thresholds that enable/disable access to the coexistence pool, or 3) configuring a priority threshold for accessing the coexistence pool.

In accordance with the above-described embodiments, the UE-A may notify the assisted UE (i.e., UE-B) as to whether preferred or non-preferred resources are coming from an NR resource pool or coexistence resource pool, e.g., by indicating a resource pool which is pre-configured with coexistence enabled.

In accordance with the above-described embodiments, the UE-A can use the 1st or 2nd stage SCI, a MAC CE, or RRC signaling to indicate that the resource selection assistance set falls in a coexistence enabled resource pool.

In accordance with the above-described embodiments, when the UE-B receives resource selection assistance information with a coexistence indication, the received assistance information may be deprioritized in order to reduce the chances of colliding with LTE devices, regardless of whether it is preferred or non-preferred.

In accordance with the above-described embodiments, when the UE-B receives a non-preferred resource set with a coexistence indication, the non-preferred resource set can be excluded from the available resource selection window, even if the remaining resources after the exclusion are below a threshold.

In accordance with the above-described embodiments, the assistance information received from the UE-A indicating preferred/non-preferred resources in a coexistence band can be overridden by the UE-B based on an indication from its LTE modem of a future reservation by an LTE device in the coexistence band.

In accordance with the above-described embodiments, the UE-B can apply a CR_limit in the coexistence band that is different from that applied to the NR band. In addition, transmissions done in the NR band can either count or not count towards the CR_limit of the coexistence band based on pre-configuration.

Applicability of Coexistence Between NR Mode 1 Resource Selection Scheme and LTE V2X Modes 3 and 4

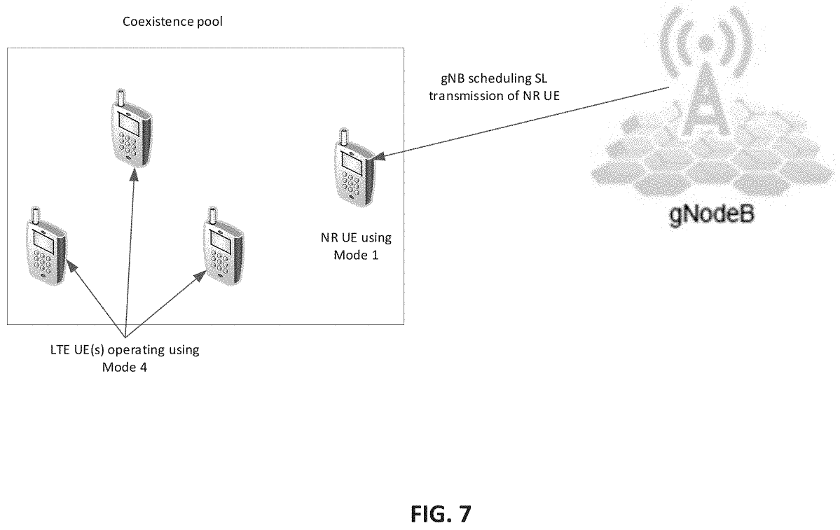

FIG. 7 illustrates Mode 4 LTE UEs coexisting with NR Mode 1 UEs, according to an embodiment.

Referring to FIG. 7, in NR Mode 1, the resource selection for NR SL transmissions is done by a gNobeB (gNB), which allows for a coordinated resource selection strategy that reduces the chances of collisions between neighboring devices. In particular, all resource selections may be performed by a centralized entity (i.e., the gNB), thus eliminating the chances of having resource selection overlap between UEs that are served by the same gNB. However, advantages of the Mode 1 resource selection scheme of NR is not immediately realizable in coexistence bands because, in the coexistence band, the LTE V2X devices can operate in Mode 4 and the gNB will not be aware of the reservations done by the LTE UEs.

There may be an exception to this case, however, when the same gNB/eNB is controlling the spectrum. In that sense, the eNB/gNB performs the scheduling for both LTE and NR SL communications. In this scenario, nothing is needed as an NR mode-1 UE receives scheduling from the eNB/gNB, does not need to know it is scheduled on a shared carrier, and applies the grant as received.

In addition, there may not resource selection coordination between eNB and gNBs when the eNB is operating in Mode 3. To address this drawback, coexistence between Mode 1 NR UEs and their LTE counterparts using Mode 3 or Mode 4 may be enabled/disable based on a resource pool configuration. More specifically, the configuration should to indicate that the resource pool is shared between Mode 1 NR UEs and Mode 4 and Mode 3 LTE UEs. This configuration can also depend on a priority threshold or multiple priority thresholds based on CBR. For example, only UEs with a priority value below the threshold will be able to use the coexistence resource pool.

Another option is to rely on the sensing information available at the NR UEs. More specifically, an NR UE can identify the occupied resources of LTE V2X devices, either through measuring the received power (i.e., energy detection) or by decoding future LTE reservation, if it has an LTE Modem. In particular, the different operations are provided for 1) an NR device that does not have an LTE modem, and 2) an NR device that has an LTE modem and reports sensing information to a gNB.

NR Device not Including an LTE Modem

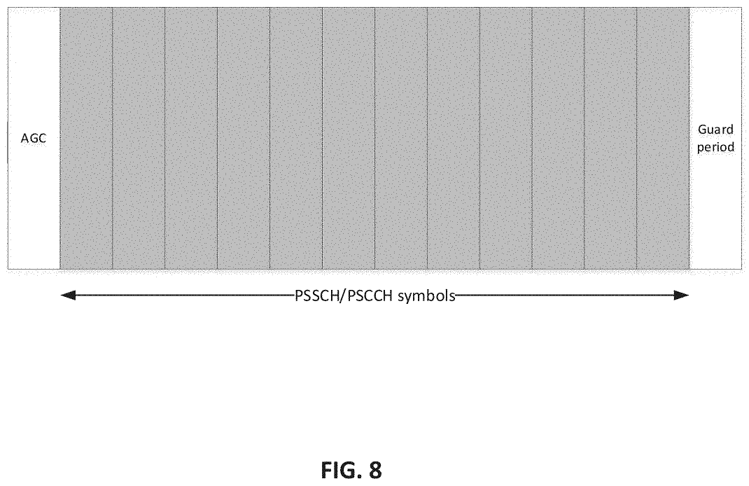

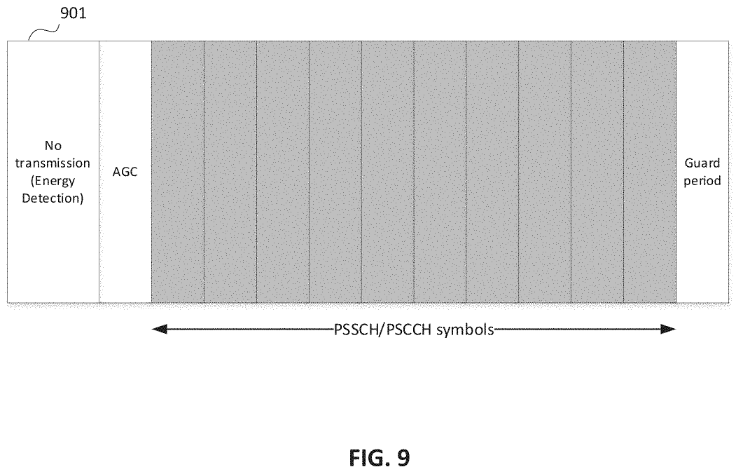

In this case, a simple approach is for the NR device to follow the resource reservations performed by the gNB. However, energy detection should be performed before transmission in order to identify whether the resource is occupied by an LTE device. Thus, the NR UE should be able to sense before transmitting. For this purpose, the following can be applied (where two types of slots are defined):
Slot format Type A: FIG. 8 illustrates a type A slot, according to an embodiment. Referring to FIG. 8, an SL slot is provided, wherein a first symbol is used for automatic gain control (AGC) and a last symbol is a guard period used for switching between transmission/reception. The symbols between first and last symbols are used for PSCCH/PSSCH. Although not illustrated, PSFCH can also be present.
Slot format Type B: FIG. 9 illustrates a type B slot, according to an embodiment. Referring to FIG. 9, different from the slot in FIG. 8, at the beginning of the slot, a zone 901 (i.e., a duration of one or more OFDM) is reserved for the UE to do energy detection. No random backoff is needed, so that a receiving SL NR UE knows where to expect the start of a slot B.

It can be assumed that the LTE and NR SL UEs coexisting on the same carrier are slot-synchronized. In such a case, the system can take advantage of this time-synchronization to select which slot format to use. For example, when the beginning of an NR slot coincides with the beginning of an LTE subframe, slot format type B may be used, since the UE should perform energy detection to make sure that the slot is unoccupied.

When the beginning of an NR slot is at a different time than the beginning of an LTE subframe (e.g., at ½ an LTE subframe), and if the UE has energy-sensed in the previous slot, the UE knows that the slot is empty (i.e., no LTE subframe will begin at that time), thus there is no LTE transmission. Given that the UE is scheduled by the gNB, there is no conflict. Thus, type B can be used.

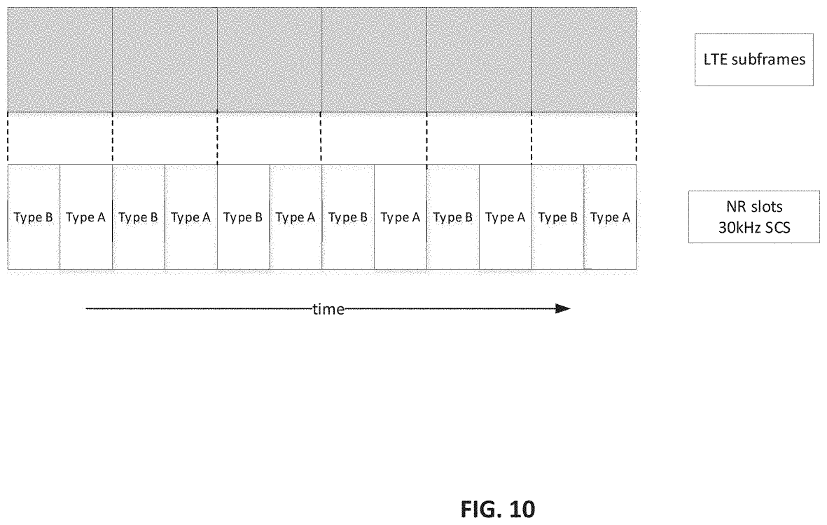

FIG. 10 illustrates a mapping of type A slots and type B slots, according to an embodiment; Referring to FIG. 10, a 15 kHz LTE SCS and a 30 kHz NR SCS are used. Every other frame is type B.

In order to be able to selectively use type B, the UE should have information on the presence/absence of the LTE subframe transmissions. Thus, type B can be used if the UE has energy-sensed in a previous slot overlapping with the LTE subframe. For a 30 kHz SCS, this implies that the UE should ideally energy sense every other slot, at the beginning of the LTE subframe.

After energy sensing, if a resource is determined as occupied (e.g., if the measured RSRP level is above a threshold), the transmission can be abandoned and feedback can be provided to the gNB to indicate that the transmission did not occur. The indication to the gNB can be different from the regular ACK/NACK provided to the gNB. That is, it may be preferable to distinguish if a transmission is dropped due to LTE occupancy from when the transmission was done but was not successfully decoded by the receiving UE. For example, if a transmission is abandoned, it will not be combined at the receiver and a new TB can be sent, whereas in case of a retransmission, the receiving UE may benefit from combining and thus the TB should be retransmitted again.

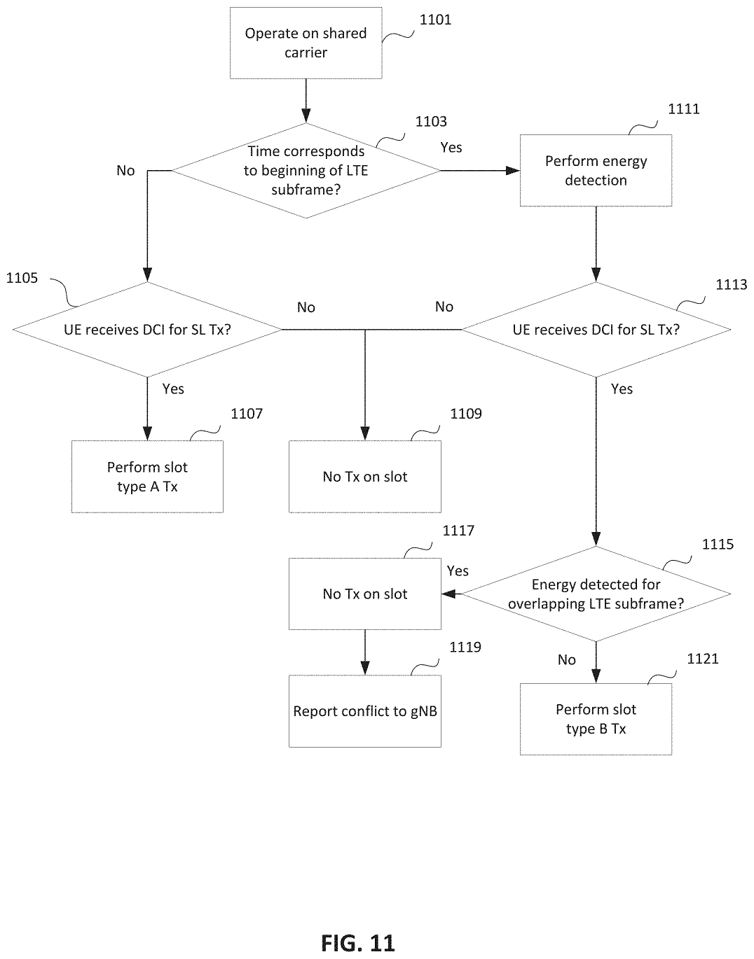

FIG. 11 is flowchart illustrating a UE transmission operation, according to an embodiment.

Referring to FIG. 11, in step 1101, an NR UE is to operates on a shared carrier.

In step 1103, the NR UE determines whether the time corresponds to the beginning of an LTE subframe. That is, the NR UE determines whether the beginning of an NR slot coincides with the beginning of an LTE subframe.

In response to determining that the time does not correspond to the beginning of an LTE subframe in step 1103, the NR UE determines if it has received DCI for an SL transmission in step 1105.

In response to the NR UE determining that it has received DCI for an SL transmission in step 1105, the NR UE performs a slot type A transmission in step 1107.

However, in response the NR UE determining that it has not received DCI for an SL transmission in step 1105, the NR UE does not perform a transmission in step 1109.

In response to determining that the time corresponds to the beginning of an LTE subframe in step 1103, the NR UE performs energy detection in step 1111. As described above, when the beginning of an NR slot coincides with the beginning of an LTE subframe, the NR UE should perform energy detection to make sure that the slot is unoccupied.

In step 1113, the NR UE determines if it has received DCI for an SL transmission.

In response the NR UE determining that it has not received DCI for an SL transmission in step 1113, the NR UE does not perform a transmission in step 1109.

In response to the NR UE determining that it has received DCI for an SL transmission in step 1113, the NR UE determines whether energy has been detected for an overlapping LTE subframe in step in step 1115.

In response the NR UE determining energy has been detected for an overlapping LTE subframe in step 1115, the NR UE does not perform a transmission in step 11117. That is, based on the energy detection in step 1111, if a resource assigned in the DCI is determined as occupied (e.g., if the measured RSRP level is above a threshold), the transmission can be canceled.

In step 1119, the NR UE transmits a conflict report to the gNB. That is, when resource assigned in the DCI is determined as occupied and the transmission is canceled, feedback can be provided to the gNB to indicate that the transmission did not occur (e.g., a message indicating a conflict).

NR Device Having an LTE Modem and Reporting Sensing Information to a gNB

When an NR includes an LTE modem, it may report sensing information obtained using the LTE modem to the a gNB. For example, the NR device may be able to identify future reservations by the neighboring LTE devices and provide this assisting information to the gNB. This assisting information may be in the form of preferred or non-preferred resource sets. In addition, the processing and scheduling time should be taken into consideration when providing the assistance information to the gNB. For example, there may be a minimum separation between the assistance reporting and the preferred/non-preferred resources in order to allow for proper processing at the gNB or otherwise the assistance reporting should be discarded.

The gNB can consider the received assisting information when performing its resource selection and avoid assigning these resources to NR devices in order to avoid collisions.

In addition, the assisting information received by the gNB, from an NR device, can also be applied to other NR devices within a region. For example, if an NR UE falls in a zone X and notifies a gNB that a resource in the coexistence resource pool is occupied by LTE devices, then the gNB can avoid scheduling this resource to all UEs within the same zone. In this case, the NR UE devices may be expected to report their locations (e.g., their zone) to the gNB when requesting resource selection for their SL transmissions. This can be used to limit the reporting, and the time a UE should performing sensing.

Assuming that the gNB knows the UE location (e.g., by reporting or by monitoring an SL), the gNB may select a subset of UEs to perform and report the sensing. Thus, the gNB may send a command to a UE indicating a request to sense and report and/or an indication of resources on which to send the report.

More specifically, a gNB can send a request to one or more NR UEs, which have indicated an LTE sensing capability (i.e., the UE has an LTE modem), within a region to perform sensing and report the resources occupancy. This request can be done explicitly by using DCI with a specific field or by using a MAC CE or RRC configuration.

In addition, the request can be done implicitly by providing a configured grant to a specific UE for reporting the sensing information and activating that specific grant. In addition, the request can be targeted to a specific UE by using a cell-radio network temporary identifier (C-RNTI) or to all UEs within a specific area by indicating a zone identifier (ID).

The gNB can also indicate that the sensing information can be sent in the payload or as a MAC CE to the gNB. In this case, such information can be carried in a PUSCH scheduled by the DCI or to be multiplexed over the PUCCH with other control signaling. In addition, to reduce the signaling overhead, a UE can use a configured grant through RRC signaling to enable the reporting of the sensing information to one or more UEs in an SPS manner. RRC signaling may also be used to report the sensing results.

In accordance with the above-described embodiments, coexistence between Mode 1 NR SL UEs and Mode 3 or Mode 4 LTE V2X UEs can be enabled or disabled per resource pool, e.g., based on one or more priority thresholds or a measured CBR value.

In accordance with the above-described embodiments, an NR UE can abandon a transmission on SL resource reservation from a gNB, if it detects that the resource is occupied by an LTE device. In this case, a feedback indicating the transmission drop can be passed to the gNB to schedule a retransmission if needed.

In accordance with the above-described embodiments, a new slot format (slot format type B) is provided, which can be used to enable NR UEs to perform energy detection before transmitting in the coexistence band, thus allowing the NR UEs to avoid collisions with LTE UE transmission in the coexistence band.

In accordance with the above-described embodiments, resource utilization may be improved by limiting the usage of slot type B to a first NR slot contained within the beginning of the LTE subframe. That is, if an LTE subframe overlaps with more than one NR subframe, the UE can declare the remaining slots, other than the first one, as unoccupied by LTE after performing the energy detection in the first slot.

In accordance with the above-described embodiments, for NR UEs, which include LTE modems, operating in Mode 1 in a coexistence band, the sensing information obtained by the LTE modem can be passed to the gNB for better resource selection.

In accordance with the above-described embodiments, a gNB can send a request for one or more NR UEs to obtain the LTE sensing information for coexistence band. The request can be done by using a DCI, a MAC CE, or by using an RRC configuration.

In accordance with the above-described embodiments, a gNB can provide a single or periodic resource reservations for NR UEs to provide sensing information from their LTE modem over the coexistence band. In this case, the NR UE can use the MAC CE or the payload to carry the sensing information to the gNB.

In accordance with the above-described embodiments, feedback of sensing information from the NR UEs equipped with LTE modems can be subject to processing time requirements, whereby the feedback may dropped if it cannot be received by the gNB on time.

In accordance with the above-described embodiments, feedback of LTE sensing information from the NR UEs equipped with LTE modems can be accompanied by the UE's location (e.g., a zone ID) to allow a gNB to reuse this information when scheduling neighboring NR UEs.

Constraints on Coexistence for Given Resource Pools

In NR Rel-18, it is expected that Mode 2 NR devices will be able to dynamically coexist and perform resource selections in LTE V2X resource pools. That is, NR devices should be able to perform resource selection in LTE V2X resource pools, wherein the LTE V2X UEs would have higher priority to occupy such resources. However, to avoid performance degradation on LTE V2X devices, the coexistence between NR and LTE V2X devices should be enabled or disabled per resource pool.

In addition, coexistence may be restricted to NR UEs with specific priorities in order to reduce the impact to LTE V2X devices. More specifically, a priority threshold can be configured per resource pool, wherein NR devices with priority values below the threshold are allowed to coexist with the LTE V2X UEs.

In addition, a limitation on coexistence may be based on the occupancy of the LTE V2X resource pool. More specifically, one or more CBR thresholds can be configured for the LTE V2X resource pool and NR devices are allowed to coexist when the measured CBR is below the preconfigured threshold. Different thresholds can be configured for different priorities. In addition, NR UEs performing energy detection can also be exempted from this restriction since they will be able to avoid collisions with LTE UEs transmitting in the coexistence band.

In accordance with an embodiment, three CBR option are provided:
CBR_all: the CBR is determined on all resources, regardless of whether they are NR or LTE. In other words, the CBR is calculated by dividing the total number of resources (in the NR and coexistence band) that have an RSSI above a threshold over the total number of available resources across the two bands.
CBR_LTE: the CBR is determined based on RSSI measurements over the resources in the coexistence band only.
CBR_NR: the CBR is determined based on RSSI measurements over the resources in the NR band only.

These different CBRs are shown in Table 1 below.

TABLE 1

| | | | Received directly |
|---|---|---|---|
| CBR Type | Source | Measured band | from LTE modem |
| CBR_ALL | Measurement of | NR and | No |
| | pre-configuration | coexistence bands | |
| CBR_LTE | Measurement (if | Coexistence band | No |
| | an LTE modem | | |
| | exists) or pre- | | |
| | configuration | | |
| CBR_NR | Measurement | NR band | Yes |

When comparing against the CBR threshold for coexistence band access, the UE can use any of three defined CBRs, or a combination thereof.

In terms of priority, both the NR and LTE priorities may be considered, if possible (e.g., if the UE can get the LTE priorities or if the NR UE also has an LTE modem). If the UE can get the LTE priorities, it can overlap with LTE transmissions with lower priority. Thus, the CBR thresholds should be different based on whether the UE can obtain the LTE priorities or not.

In addition, an NR UE can obtain the CBR level for the coexistence band by performing sensing on the coexistence band or by receiving the measured CBR by the LTE modem if both modems exist in the same UE.

The CBR measurement may also be done in the NR resource pool since more coexistence attempts are expected when the CBR of the NR resource pool is high and thus the priority threshold should be set to a lower value to reduce the chances of coexistence. However, the thresholds for the measured CBR outside of the coexistence pool can be different from those when CBR is actually measured in the coexistence pool.

In addition, a pre-configured CBR value can also be considered if a UE does not perform enough sensing.

Resource pool partitioning can also be considered for coexistence. More specifically, for each partition, a separate CBR and priority threshold for coexistence can be configured. For example, if a coexistence resource pool is divided into two partitions and an NR device only meets the required priority threshold for coexistence of one partition, then it will be allowed to coexist in this partition only.

In accordance with an embodiment, a determination to allow NR-LTE coexistence may be based on an NR UE also having an LTE modem, as it will have access to more information with the LTE modem (e.g., NR UE may identify the LTE resource reservations from the LTE PSCCH). The NR UE, using its LTE modem, can also indicate the resources reserved by sending an LTE PSCCH. In such a case, a flag per resource pool is needed to indicate whether only NR UEs with LTE modem can operate in the pool or not.

Generally, the resource pool configuration may include two set of parameters:
A set of parameters for NR UEs with LTE modems
A set of parameters for NR UEs without LTE modems

This dual configuration may be beneficial since a UE with an LTE modem can obtain more information than one without, and thus can coexist more easily and more effectively. Accordingly, parameters for NR UEs with LTE modems may be more aggressive than parameters for UEs without LTE modems.

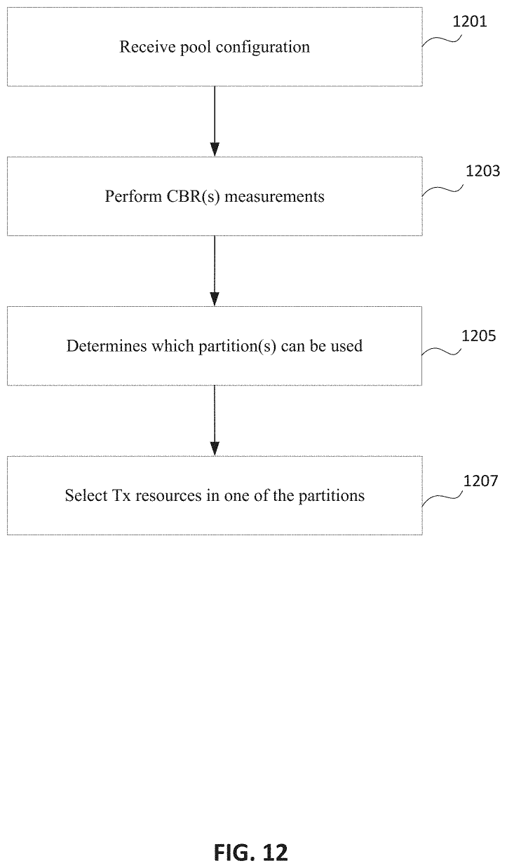

FIG. 12 is a flowchart illustrating an NR UE operation on a shared carrier according to an embodiment.

Referring to FIG. 12, in step 1201, the NR UE receives the pool configuration. For example, the pool configuration may be received through an RRC message or it may be pre-configured. The pool configuration message may include CBR(s) threshold value(s) per priority(ies), the pool partition, etc.

In step 1203, the NR UE performs the CBR(s) measurements. The CBR(s) measurements may be performed over all the partitions or per partition.

In step 1205, the NR UE determines which partition(s) it can use (i.e., where the CBR is lower than the received CBR threshold).

In step 1207, the NR UE selects transmission resources in one of the used partitions.

In accordance with the above-described embodiments, coexistence between Mode 2 NR SL UEs and Mode 3 or Mode 4 LTE V2X UEs can be enabled or disabled per resource pool, e.g., based on one or more priority thresholds.

In accordance with the above-described embodiments, coexistence thresholds can be dependent on CBR (e.g., priority thresholds can be set lower when CBR is high) that is measured in the NR band, the coexistence band, or both. Alternatively, the CBR can be pre-configured if not enough sensing is done.

In accordance with the above-described embodiments, resource pool partitioning can be applied in case of coexistence. In particular, coexistence can be limited to one or more partitions within the resource pool based on pre-configured CBR or priority thresholds.

In accordance with the above-described embodiments, an NR UE's ability to access a coexistence resource pool can be contingent on whether it has an LTE modem or not. Alternatively, different sets of CBR/priority thresholds for coexistence can be configured for NR UEs with LTE modems and NR UEs without LTE modems and whether they are able to perform energy detection or not.

Impact of Power Saving on Coexistence

In NR Rel-17 a feature was added to provide power saving. Specifically, partial sensing and random resource selection procedures were introduced to allow NR UEs to save power by avoiding contiguous sensing as set forth in NR Rel-16. In addition, when operating in the LTE band, a UE is allowed to perform partial sensing or random resource selections.

However, despite the advantages these mechanisms have in saving UE power, they also may impact an NR UE's ability to detect an LTE reservation, e.g., when sensing before transmission is not enabled (i.e., an NR UE does not perform energy detection to identify the presence of LTE transmissions before transmitting in the coexistence band). In particular, if an NR UE has an LTE modem, which it relies on for detecting the LTE reservations in the coexistence band, then this modem should contiguously sense in order to identify all reservations by neighboring UEs. If only partial sensing is employed, then some LTE reservations might not be detected, resulting in collisions between the LTE reservations and the NR reservations in the coexistence band. Further, if only partial sensing is employed, then a set of candidate slots will have to be identified for transmission, which may delay NR transmissions when there are no potential candidate subframes already identified and sensed by the LTE modem.

Additionally, a set of candidate slots that are identified by the LTE modem may not work well with NR reservations (e.g., if an NR UE needs to perform two transmissions separated by 15 slots but all the candidate slots that are available are more than 15 slots away).

Therefore, for an NR UE to operate in the coexistence band, it may still be required to perform full sensing in the coexistence band in order to be able to detect LTE reservations by neighboring LTE devices and accordingly avoid them.

In addition, performing partial sensing by NR UEs when operating in the coexistence band may limit their ability to detect future reservations by NR UEs in the coexistence band. This can result in collisions between NR devices in the coexistence band, which can further increase the interference incurred by the LTE devices on such resources. For example, if an NR UE selects resource X to transmit, this resource may also be used by a faraway LTE device. In this case, the LTE UE may be able handle the interference. However, if this same resource is selected by multiple NR UEs, the accumulated interference from these devices may result significant interference to the LTE device.

Therefore, in accordance with an embodiment, to reduce the complexity and allow for some power saving, NR UEs may be selectively allowed to use partial sensing or random resource selection. More specifically, a priority threshold may be configured for each resource pool, wherein NR UEs below the threshold are allowed to transmit based on partial sensing or random resource selection (i.e., without full sensing by an LTE modem, an NR, modem or both). In addition, the priority threshold configured can to be dependent on a measured CBR value. The ability of NR UEs to perform partial sensing or random resource selection to access a coexistence pool can also be enabled/disabled per resource pool. This type of relaxation can also be applied to the LTE modem in order to preserve power. In particular, an NR UE with high priority packets to transmit in the coexistence band and has an LTE modem can rely on LTE partial sensing for detecting LTE future reservations. However, to reduce the impact on the LTE UEs, an NR UE may be required to perform LTE partial sensing over the coexistence band with high intensity (i.e., monitoring a larger number of possible periods) by configuring a different value of K from that used for regular LTE transmissions (e.g., a K set with all ones in case of performing an NR transmission in the coexistence band). The number of ones within the K value can be also dependent on the priority of the NR transmission.

Herein, K is a value that is converted into bits and each bit may correspond to a specific monitored period value. If all bits are set to 1, then all possible periods will be monitored to detect as much as possible of the LTE transmissions.

In accordance with the above-described embodiments, only full sensing UEs (i.e., NR-based full sensing, LTE-based full sensing, or both) may be allowed to perform transmissions in the coexistence band with LTE UEs. The indication of the required full sensing can be configured per resource pool.

In accordance with the above-described embodiments, a priority threshold can be configured to allow partial sensing and random resource selection NR UEs to coexist in the LTE band. The priority threshold can be configured per resource pool and/or can be dependent on measured CBR.

In accordance with the above-described embodiments, a K value can be configured for partial sensing in the coexistence band for NR transmissions, which is different from a K value configured for partial sensing in the coexistence band for LTE transmissions.

In accordance with the above-described embodiments, an ability of power saving NR UEs to access coexistence resource pool(s) can be enabled/disabled per resource pool.

Limitation on the Number of Slots Per LTE Subframe for Use by NR UEs

In some cases, NR UEs are not able to perform energy detection before transmission in the coexistence band in order to identify resource occupied by LTE UEs (e.g., if the NR UEs do not have enough processing capabilities or if they do not have LTE modems). In such cases, collisions can occur between the NR and LTE transmissions in the coexistence band, resulting in higher interference levels.

In accordance with an embodiment, to mitigate interference an NR UE may be restricted from transmitting in some slots in the coexistence band. Here, it is assumed that the NR UE is not able to perform energy detection on LTE UEs.

In particular, in an NR SL, multiple SCSs are considered (e.g., up to 120 KHz) for the PSCCH/PSSCH, unlike LTE which uses only one SCS (i.e., 15 KHz). The additional SCSs of NR offer an opportunity for latency reduction since the slot duration can be set shorter.

In a case of coexistence, NR UEs may be allowed to operate on a different SCS than that used by the LTE UEs. For example, an NR UE can operate at 60 KHz SCS, whereas the LTE UEs operate at 15 KHz SCS. In this case, the slot duration of the NR UEs will be much lower than that of the LTE UEs (e.g., 1 LTE subframe will overlap 4 NR slots). Consequently, a collision may occur between one LTE UE and multiple NR UEs within one subframe, or if an NR UE transmits over 4 consecutive slots, then it will collide with the LTE UE on all 4 consecutive slots, resulting in excessive interference to the LTE UE.

To address these types of problems, a limit may be placed on the maximum number transmissions permitted by an NR UE per LTE subframe in a coexistence pool, or a limit may be placed on the maximum number of NR UEs that can transmit per LTE subframe in a coexistence pool.

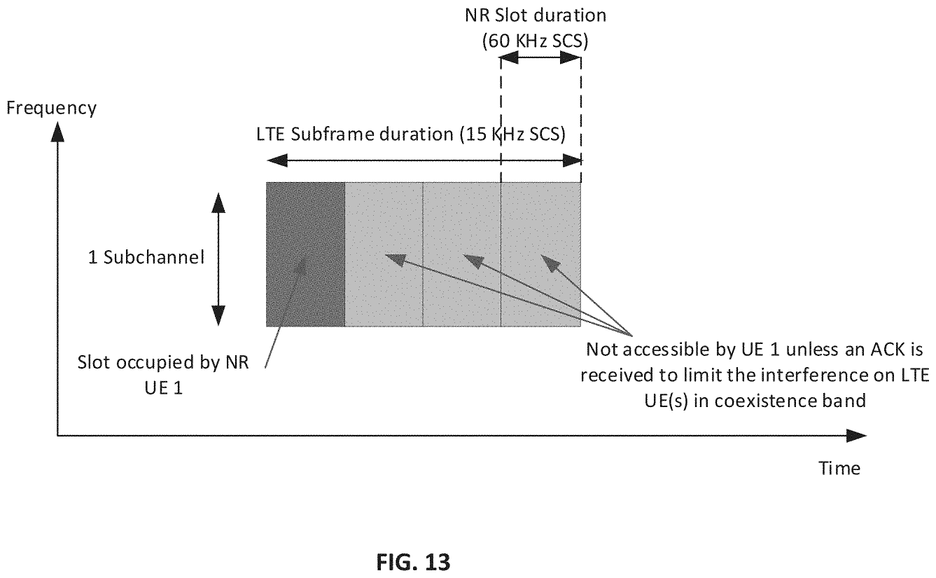

FIG. 13 illustrates an example of a limit on a maximum number transmissions by an NR UE per LTE subframe in a coexistence pool, according to an embodiment.

Referring to FIG. 13, NR UEs may be prevented from transmitting on all of multiple slots that fall within one LTE subframe in order to avoid colliding with the same LTE UE. In other words, the number of slots that can be used by the NR UEs within one LTE subframe may be restricted. In this case, if an LTE UE experiences interference, the interference will be limited to only a subset of the symbols within the subframe and the LTE UE may still be able to recover the message.

In addition, an NR UE that fails to detect an LTE transmission will avoid collisions of all its reserved slots that falls within the same subframe. This restriction can be lifted if the NR UEs can provide immediate feedback within the same LTE subframe.

More specifically, if an NR UE can detect a PSCCH and provide feedback on a PSFCH channel within the same LTE subframe duration, then the transmitting NR UE will be able to identify whether interference occurred or not with an LTE UE and accordingly decide whether or not to use the remaining slots within the subframe. For example, if an LTE subframe covers 8 NR slots due to the difference in the SCS and an NR UE receives an ACK in response to the transmission that was done on slot 1 by slot 4, then the NR UE can identify that this slot was not used by any LTE UE and can immediately reuse the remaining slots within the LTE subframe (i.e., the remaining 4 slots within the LTE subframe). This may be more beneficial in cases in which only one NR UE is allowed to transmit within an LTE subframe.

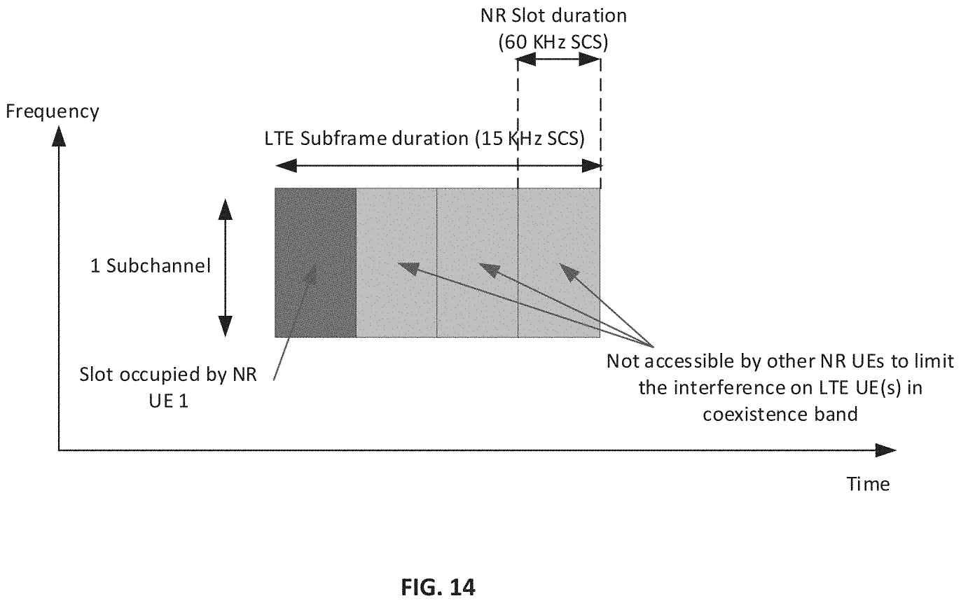

FIG. 14 illustrates an example of a limit on a maximum number of NR UEs that can transmit per LTE subframe in a coexistence pool, according to an embodiment.

Referring to FIG. 14, a limit can be imposed on the number of slots that can be used by NR UEs within an LTE subframe. For example, if the limit is set to one and one slot is already reserved by an NR UE within an LTE subframe X, then all the remaining slots within subframe X will be considered as reserved from the perspective of neighboring NR UEs.

The above-described restrictions can also be similarly applied to the frequency domain.

More specifically, a limit can exist on the number of NR UEs that are allowed to transmit within a slot. For example, if the number of subchannels is 2 and the limit on the number of NR UEs transmitting in a slot is set to one, if an NR UE uses one subchannel in slot X, then the remaining subchannel cannot be used by any other NR UEs. Similarly, if an NR UE uses subchannel X for its transmission, then it may not be allowed to use the adjacent subchannels (e.g., subchannels X+1 and X−2) in order to reduce the chances of colliding with an LTE subchannel. These types of restrictions are applicable when an LTE subchannel is configured to be larger than an NR subchannel (i.e., an LTE subchannel covers more RBs than the NR subchannel).

Additionally, it may be necessary to maintain a consistent interference level to the LTE UE across a subframe. In this case, if a collision occurs over a resource reserved by an LTE, then this collision should occur with only one UE, rather than multiple UEs, which would result in different interference levels. In accordance with an embodiment, this can be done by restricting the number of NR UEs that can transmit in NR subchannels/slots that are overlapping with either an LTE UE reservation or an LTE subframe/subchannel to one NR UE.

In accordance with the above-described embodiments, to reduce the chances of interference between NR and LTE UEs in the coexistence band, a restriction on the number of transmissions by an NR UE on slots within one LTE subframe can be applied. The restriction can be alleviated, if an NR UE can provide a feedback within one LTE subframe.

In accordance with the above-described embodiments, to reduce the chances of interference between NR and LTE UEs in the coexistence band, a restriction on the number of NR UEs transmitting on slots within one LTE subframe can be applied.

In accordance with the above-described embodiments, when an NR subchannel is configured to be smaller than its LTE counterpart, a restriction on the number of consecutive subchannels that are occupied by an NR UE transmission within one LTE subchannel can be applied.

In accordance with the above-described embodiments, when an NR subchannel is configured to be smaller than its LTE counterpart, a restriction on the number of NR UEs transmitting on subchannels within one LTE subchannel can be applied.

In accordance with the above-described embodiments, in order to maintain a consistent interference level incurred by an LTE UE, the number of NR UEs allowed to transmit in NR subchannels/slots that are overlapping with either an LTE UE reservation or an LTE subframe/subchannel to one NR UE may be restricted, e.g., only one NR UE may be allowed to transmit in slots/subchannels overlapping with an LTE UE reservation or an LTE subframe/subchannel.

Impact of DRX on Coexistence

In NR SL, DRX is introduced to allow UEs to save power.

More specifically, a DRX cycle includes wake-up and sleep durations. In a sleep duration, a UE is expected to have its radio frequency (RF) circuitry off in order to preserve power, whereas in a wake-up duration the UE is active and performing reception.

In order to transmit in a coexistence band, an NR UE is expected to have minimal impact on LTE UEs. As described above, this often requires that NR UEs perform sensing in order to detect reservations and transmissions by LTE UEs to avoid in order to reduce collisions. To achieve this, DRX may be disabled when an NR UE operates in the coexistence band, a minimal contiguous sensing duration may be pre-configured per resource pool for the coexistence band, a UE may be required to perform partial sensing in order to detect LTE/NR reservations in order to operate in the coexistence band, or required partial sensing by a UE may be limited to a subset of configured periods or a subset of K values.

More specifically, an NR UE may perform energy detection before transmitting in the coexistence band as discussed above.

Further, DRX can be disabled if an NR UE operates in the coexistence band because the coexistence band generally increases available bandwidth for transmission in order to allow high data rates. Usually, high data rate UEs have access to more power and thus can afford to have DRX active while using the coexistence band. In addition, the duration in which the UE should send high data rates is also expected to be limited and thus should not have a significant impact on the UE performance if DRX is disabled for this duration.

Similar to NR Rel-17, an NR UE may perform sensing during a DRX off cycle so that it does not miss the reservations by neighboring LTE UEs. For example, an NR UE may be configured with a minimum sensing duration before transmitting in the coexistence band. This duration can also be dependent on priority and can be configured per resource pool. In addition, this duration can depend on other parameters, such as CBR.

During a contiguous sensing duration, an NR UE will wake-up and perform sensing for during the duration, before performing any transmission in the coexistence band. This sensing can be done irrespective of its DRX cycle. In addition, this sensing duration can be required to be done by an LTE modem to detect LTE reservations, by an NR modem to detect NR reservations in the coexistence band, or by both modems.

In addition, the sensing duration can be configured to be contiguous and can be related to a location (e.g., X slots before, based on pre-configuration) of the resource window in which the NR UE is expecting to transmit in the coexistence band. In addition, the sensing duration can end X slots before the first resource within the resource selection window subject to processing time requirements.

The duration for contiguous sensing can also be configured per resource pool.

The duration for contiguous sensing can also be set to be equal to the largest configured period of LTE in the coexistence band in order to detect all periodic LTE reservations. Alternatively, it can be set to be equal to the signaling window in order to detect aperiodic reservations of NR devices in the coexistence band.

A UE may perform partial sensing with all values of K set to 1 (e.g., setting the 3rd bit of K value to 1 indicates that a UE is required to monitor the 3rd instance of each of the configured periods for potential reservations) or a subset of the values of K to detect all/some of the periodic reservations performed by LTE and accordingly avoid them. This sensing may be done irrespective of the DRX cycle status (i.e., whether the UE is in the active or sleep duration of its DRX cycle). This sensing may also be limited to a subset of the possible configured periods.

In addition, the sensing may be limited to configured periodicities of LTE (or the periodicities that divide the LTE possible periods) in order to avoid consistent collisions between NR and LTE transmissions in the coexistence band. In this case, a UE identifies a set of potential candidate slots for transmitting its payload in the coexistence band and performs the sensing in order to detect the LTE reservations. This sensing would be done by an LTE modem.

In addition, an NR UE may perform partial sensing (either for all periods for all values of K or a reduced partial sensing with a subset of periods and a subset of the possible values of K) in order to detect NR reservations in order to avoid collisions with NR devices that will be transmitting in the coexistence band.

In accordance with the above-described embodiments, DRX may be disabled when an NR UE operates in the coexistence band.

In accordance with the above-described embodiments, a minimal contiguous sensing duration may be pre-configured for each resource pool for a coexistence band, which allows UEs to detect reservations by NR UEs and/or LTE UEs.

In accordance with the above-described embodiments, a duration of contiguous sensing may be dependent on priority or other parameters, e.g., CBR, and may be configured for each resource pool.

In accordance with the above-described embodiments, a UE may be required to perform partial sensing to detect LTE/NR reservations in order to be able to operate in the coexistence band.

In accordance with the above-described embodiments, to save power, a required partial sensing by a UE may be limited to a subset of configured periods, or a subset of K values. The required partial sensing by the UE may also be limited to be limited to the periods configured for the LTE V2X.

Operating with Limited Periodicities in a Coexistence Band

In LTE V2X, a vehicular UE is expected to periodically transmit basic safety messages to its neighboring vehicles in order to share information (e.g., their location) to assist in avoiding crashes. Since these messages are usually transmitted periodically and the duration between two consecutive transmissions is usually low, a vehicular UE may still be able to lose one message and still operate properly. However, if a consistent collision occurs between LTE and NR transmissions, this can significantly impact the performance of LTE V2X and reduce the reliability of basic safety message transmissions, e.g., when an NR UE cannot perform energy detection in the coexistence band before transmission.

To address this type of problem, in accordance with an embodiment, periodicities that can be used by NR UEs in a coexistence band may be limited. For example, a set of possible periods for NR UEs can be limited to avoid consistent collisions with LTE UEs. That is, possible NR periodicities may be selected such that they are not factors of periodicities selected for LTE V2X.

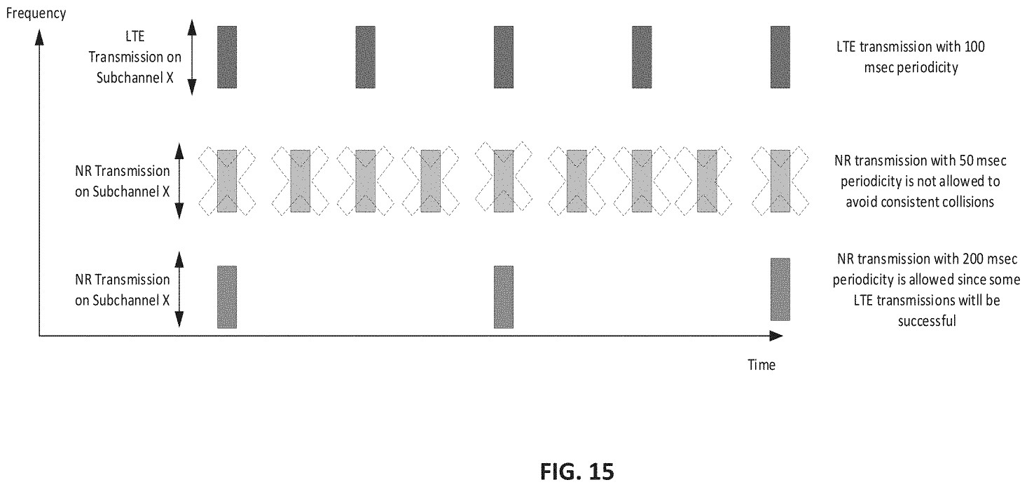

FIG. 15 illustrates a restriction on possible NR periods in a coexistence band, according to an embodiment.

Referring to FIG. 15, an NR is configured with periodicities (200, 300, 50, 20, 15) and the LTE is configured with periodicities (300 and 500). Accordingly, when operating in the coexistence band, the NR UEs will be allowed to use a reduced set of periodicities (i.e., 200, 15).

The reduced set of periodicities can be configured per resource pool and/or priority. In addition, the reduced set of periodicities can be enabled/disabled per resource pool by pre-configuration. For example, lower priority NR transmissions can be limited to the reduced subset, whereas higher priority NR transmissions can operate with a full set of periodicities in the coexistence band.

In addition, some resources may be restricted due to reservations done by other NR UEs in coexistence bands within a given duration to reduce the impact on LTE UEs. For example, in the coexistence band, if LTE is configured with periodicity 100 and if an NR UE reserves a resource on subchannel y in subframe X, then the subchannel y will be considered as blocked or reserved in subframe X+100. This ensures that if a collision occurs with an LTE UE transmitting in subframe X, then the LTE UE will still be able to succeed in the following periodic transmission. That is, this type of restriction can prevent consistent collisions between a periodic reservation of an LTE UE and multiple reservations of more than one NR UE.

The above-described embodiment may be beneficial for periodic safety messages in order to ensure that they can be received by neighboring UEs.

In addition, this type of restriction can be relaxed for a given duration. For example, if a tolerance for losing a basic safety message is 300 ms and the configured LTE periodicity is 100 ms, then for subframes X, X+100, and X+200, at least one of the subframes should not be accessible by NR UEs in order to allow the LTE UEs to transmit without interference.

These restrictions may be enabled/disabled per resource pool and may be applied only to NR UEs having a priority below a configured threshold. The threshold can also be dependent on other factors such as the CBR.

NR periodic transmissions can also be dropped all together in coexistence band, which may be done by setting a subset of possible NR periods in the coexistence band to null.

In accordance with the above-described embodiments, to reduce chances of consistent collisions, NR UEs may limited to a subset of possible periodicities when operating in a coexistence band.

In accordance with the above-described embodiments, a configured subset of periodicities may be enabled/disabled per resource pool and may be configured per priority.

In accordance with the above-described embodiments, some resources may be set as blocked from an NR UE perspective in order to avoid consistent collisions between one LTE UE and multiple NR UEs (e.g., if an NR UE uses subframe X then subframe X+100 might not be accessible by other NR UEs).

In accordance with the above-described embodiments, accessibility of resources in a coexistence band may be configured such that at least one resource within a tolerance duration of a basic safety message is not accessible by NR UEs.

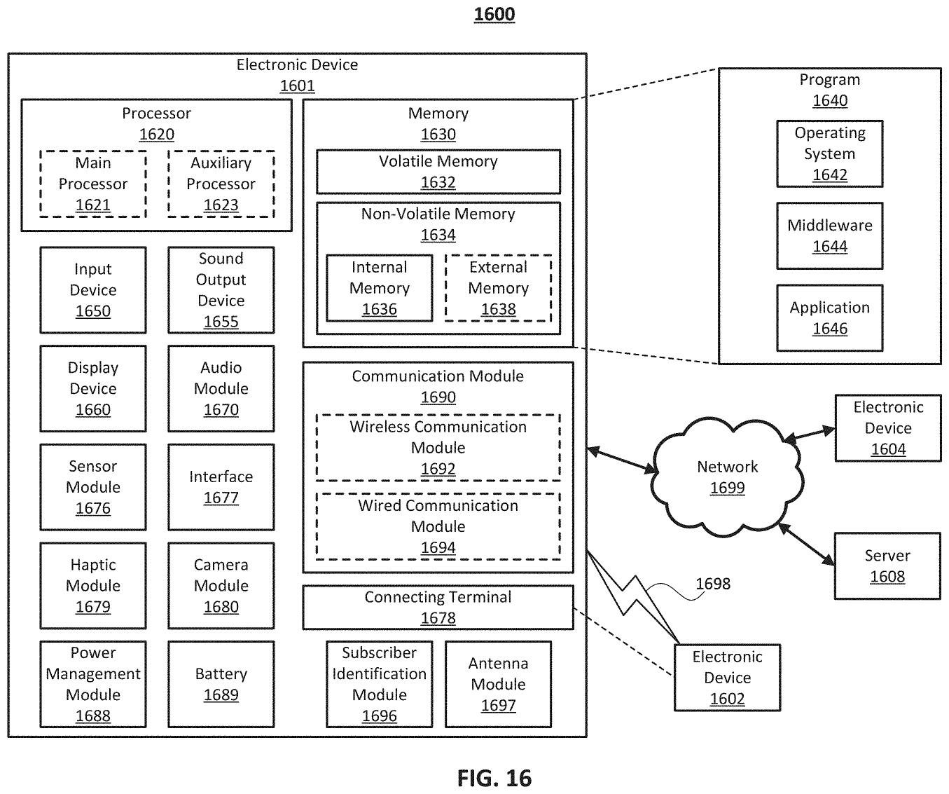

FIG. 16 is a block diagram of an electronic device in a network environment 1600, according to an embodiment.

Referring to FIG. 16, an electronic device 1601, e.g., an NR UE, in a network environment 1600 may communicate with an electronic device 1602 via a first network 1698 (e.g., a short-range wireless communication network), or an electronic device 1604 or a server 1608 via a second network 1699 (e.g., a long-range wireless communication network). The electronic device 1601 may communicate with the electronic device 1604 via the server 1608. The electronic device 1601 may include a processor 1620, a memory 1630, an input device 1640, a sound output device 1655, a display device 1660, an audio module 1670, a sensor module 1676, an interface 1677, a haptic module 1679, a camera module 1680, a power management module 1688, a battery 1689, a communication module 1690, a subscriber identification module (SIM) card 1696, or an antenna module 1694. In an embodiment, at least one (e.g., the display device 1660 or the camera module 1680) of the components may be omitted from the electronic device 1601, or one or more other components may be added to the electronic device 1601. Some of the components may be implemented as a single integrated circuit (IC). For example, the sensor module 1676 (e.g., a fingerprint sensor, an iris sensor, or an illuminance sensor) may be embedded in the display device 1660 (e.g., a display).

The processor 1620 may execute software (e.g., a program 1640) to control at least one other component (e.g., a hardware or a software component) of the electronic device 1601 coupled with the processor 1620 and may perform various data processing or computations.

As at least part of the data processing or computations, the processor 1620 may load a command or data received from another component (e.g., the sensor module 1646 or the communication module 1690) in volatile memory 1632, process the command or the data stored in the volatile memory 1632, and store resulting data in non-volatile memory 1634. The processor 1620 may include a main processor 1621 (e.g., a central processing unit (CPU) or an application processor (AP)), and an auxiliary processor 1623 (e.g., a graphics processing unit (GPU), an image signal processor (ISP), a sensor hub processor, or a communication processor (CP)) that is operable independently from, or in conjunction with, the main processor 1621. Additionally or alternatively, the auxiliary processor 1623 may be adapted to consume less power than the main processor 1621, or execute a particular function. The auxiliary processor 1623 may be implemented as being separate from, or a part of, the main processor 1621.

The auxiliary processor 1623 may control at least some of the functions or states related to at least one component (e.g., the display device 1660, the sensor module 1676, or the communication module 1690) among the components of the electronic device 1601, instead of the main processor 1621 while the main processor 1621 is in an inactive (e.g., sleep) state, or together with the main processor 1621 while the main processor 1621 is in an active state (e.g., executing an application). The auxiliary processor 1623 (e.g., an image signal processor or a communication processor) may be implemented as part of another component (e.g., the camera module 1680 or the communication module 1690) functionally related to the auxiliary processor 1623.

The memory 1630 may store various data used by at least one component (e.g., the processor 1620 or the sensor module 1676) of the electronic device 1601. The various data may include, for example, software (e.g., the program 1640) and input data or output data for a command related thereto. The memory 1630 may include the volatile memory 1632 or the non-volatile memory 1634.

The program 1640 may be stored in the memory 1630 as software, and may include, for example, an operating system (OS) 1642, middleware 1644, or an application 1646.

The input device 1650 may receive a command or data to be used by another component (e.g., the processor 1620) of the electronic device 1601, from the outside (e.g., a user) of the electronic device 1601. The input device 1650 may include, for example, a microphone, a mouse, or a keyboard.

The sound output device 1655 may output sound signals to the outside of the electronic device 1601. The sound output device 1655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1660 may visually provide information to the outside (e.g., a user) of the electronic device 1601. The display device 1660 may include, for example, a display, a hologram device, or a projector and control circuitry to control a corresponding one of the display, hologram device, and projector. The display device 1660 may include touch circuitry adapted to detect a touch, or sensor circuitry (e.g., a pressure sensor) adapted to measure the intensity of force incurred by the touch.

The audio module 1670 may convert a sound into an electrical signal and vice versa. The audio module 1670 may obtain the sound via the input device 1650 or output the sound via the sound output device 1655 or a headphone of an external electronic device 1602 directly (e.g., wired) or wirelessly coupled with the electronic device 1601.

The sensor module 1676 may detect an operational state (e.g., power or temperature) of the electronic device 1601 or an environmental state (e.g., a state of a user) external to the electronic device 1601, and then generate an electrical signal or data value corresponding to the detected state. The sensor module 1676 may include, for example, a gesture sensor, a gyro sensor, an atmospheric pressure sensor, a magnetic sensor, an acceleration sensor, a grip sensor, a proximity sensor, a color sensor, an infrared (1R) sensor, a biometric sensor, a temperature sensor, a humidity sensor, or an illuminance sensor.

The interface 1677 may support one or more specified protocols to be used for the electronic device 1601 to be coupled with the external electronic device 1602 directly (e.g., wired) or wirelessly. The interface 1677 may include, for example, a high-definition multimedia interface (HDMI), a universal serial bus (USB) interface, a secure digital (SD) card interface, or an audio interface.

A connecting terminal 1678 may include a connector via which the electronic device 1601 may be physically connected with the external electronic device 1602. The connecting terminal 1678 may include, for example, an HDMI connector, a USB connector, an SD card connector, or an audio connector (e.g., a headphone connector).

The haptic module 1679 may convert an electrical signal into a mechanical stimulus (e.g., a vibration or a movement) or an electrical stimulus which may be recognized by a user via tactile sensation or kinesthetic sensation. The haptic module 1679 may include, for example, a motor, a piezoelectric element, or an electrical stimulator.

The camera module 1680 may capture a still image or moving images. The camera module 1680 may include one or more lenses, image sensors, image signal processors, or flashes. The power management module 1688 may manage power supplied to the electronic device 1601. The power management module 1688 may be implemented as at least part of, for example, a power management integrated circuit (PMIC).

The battery 1689 may supply power to at least one component of the electronic device 1601. The battery 1689 may include, for example, a primary cell which is not rechargeable, a secondary cell which is rechargeable, or a fuel cell.

The communication module 1690 may support establishing a direct (e.g., wired) communication channel or a wireless communication channel between the electronic device 1601 and the external electronic device (e.g., the electronic device 1602, the electronic device 1604, or the server 1608) and performing communication via the established communication channel. The communication module 1690 may include one or more communication processors that are operable independently from the processor 1620 (e.g., the AP) and supports a direct (e.g., wired) communication or a wireless communication. The communication module 1690 may include a wireless communication module 1692 (e.g., a cellular communication module, a short-range wireless communication module, or a global navigation satellite system (GNSS) communication module) or a wired communication module 1694 (e.g., a local area network (LAN) communication module or a power line communication (PLC) module). The communication module 1690 may include an LTE modem and an NR modem. A corresponding one of these communication modules may communicate with the external electronic device via the first network 1698 (e.g., a short-range communication network, such as Bluetooth™, wireless-fidelity (Wi-Fi) direct, or a standard of the Infrared Data Association (IrDA)) or the second network 1699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1692 may identify and authenticate the electronic device 1601 in a communication network, such as the first network 1698 or the second network 1699, using subscriber information (e.g., international mobile subscriber identity (IMSI)) stored in the subscriber identification module 1696.

In accordance with an embodiment of the disclosure, the wireless communication module 1692 may include an LTE module and/or an NR module, which respectively include at least one LTE modem and/or at least one NR modem.

The antenna module 1697 may transmit or receive a signal or power to or from the outside (e.g., the external electronic device) of the electronic device 1601. The antenna module 1697 may include one or more antennas, and, therefrom, at least one antenna appropriate for a communication scheme used in the communication network, such as the first network 1698 or the second network 1699, may be selected, for example, by the communication module 1690 (e.g., the wireless communication module 1692). The signal or the power may then be transmitted or received between the communication module 1690 and the external electronic device via the selected at least one antenna.

Commands or data may be transmitted or received between the electronic device 1601 and the external electronic device 1604 via the server 1608 coupled with the second network 1699. Each of the electronic devices 1602 and 1604 may be a device of a same type as, or a different type, from the electronic device 1601. All or some of operations to be executed at the electronic device 1601 may be executed at one or more of the external electronic devices 1602, 1604, or 1608. For example, if the electronic device 1601 should perform a function or a service automatically, or in response to a request from a user or another device, the electronic device 1601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1601. The electronic device 1601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of transmission performed by a user equipment (UE) in a coexistence band of a first communication scheme and a second communication scheme, the method comprising:
identifying that the UE is operating on a shared carrier;
determining whether a beginning of a first communication scheme slot coincides with a beginning of a second communication scheme subframe on the shared carrier;
in response to determining that the beginning of the first communication scheme slot coincides with the beginning of the second communication scheme subframe, performing energy detection; and
performing a first type of slot transmission based on energy detected for an overlapping subframe of the second communication scheme subframe being less than a first threshold.

2. The method of claim 1, further comprising canceling a slot transmission based on the energy detected for the overlapping subframe of the second communication scheme subframe being greater than or equal to the first threshold.

3. The method of claim 2, further comprising reporting a conflict between the first communication scheme slot and the second communication scheme subframe to a base station.

4. The method of claim 1, wherein the detected energy includes a measured reference signal received power (RSRP).

5. The method of claim 1, wherein the detected energy includes a measured received signal strength indicator (RSSI).

6. The method of claim 1, further comprising performing a second type of slot transmission, in response to determining that the beginning of the first communication scheme slot does not coincide with the beginning of the second communication scheme subframe and determining that energy detected in a first slot coinciding with the beginning of the second communication scheme subframe is below a second threshold.

7. The method of claim 1, wherein the first type of slot transmission includes a transmission using a format type B slot.

8. The method of claim 7, wherein the format type B slot includes, at a being thereof, a zone reserved for energy detection, and
wherein the zone has a duration of at least one orthogonal frequency-division multiplexing (OFDM) symbol.

9. The method of claim 1, wherein the first communication scheme includes a new radio (NR) scheme, and
wherein the second communication scheme includes a long term evolution (LTE) scheme.

10. A user equipment (UE) to perform transmission in a coexistence band of a first communication scheme and a second communication scheme, the UE comprising:
a transceiver; and
a processor configured to:
identify that the UE is operating on a shared carrier;
determine whether a beginning of a first communication scheme slot coincides with a beginning of a second communication scheme subframe on the shared carrier;
in response to determining that the beginning of the first communication scheme slot coincides with the beginning of the second communication scheme subframe, perform energy detection; and
perform a first type of slot transmission based on energy detected for an overlapping subframe of the second communication scheme subframe being less than a first threshold.

11. The UE of claim 10, wherein the first communication scheme includes a new radio (NR) scheme, and
wherein the second communication scheme includes a long term evolution (LTE) scheme.

12. A method of transmission performed by a user equipment (UE) in a coexistence band of a first communication scheme and a second communication scheme, the method comprising:
receiving, from an assisting UE, resource assistance information, wherein the resource assistance information is determined by the assisting UE based on a first communication scheme resource pool and a coexistence resource pool; and
selecting a resource for transmission based on the received assistance information and sensing information of the first and second communication schemes.

13. The method of claim 12, wherein the resource assistance information is generated by the assisting UE further based on the sensing information of the first and second communication schemes.

14. The method of claim 12, wherein resources in the first communication scheme resource pool have higher priorities than resources in the coexistence resource pool.

15. The method of claim 12, wherein the resource assistance information includes resources that are subject to coexistence.

16. The method of claim 12, wherein the resource assistance information indicates that a resource pool preconfigured to the UE is the coexistence resource pool.

17. The method of claim 12, wherein the resource assistance information includes at least one of preferred or non-preferred resources selected by the assisting UE.

18. The method of claim 12, further comprising disabling resource selection from the coexistence band based on a determined channel busy ratio (CBR).

19. The method of claim 18, wherein the CBR is determined based on one of:
a measured received signal strength indicator (RSSI) of all resources in the first communication scheme resource pool and the coexistence resource pool,
a measured RSSI of resources in the coexistence resource pool only, or
a measured RSSI of resources in the first communication scheme resource pool only.

20. The method of claim 12, wherein, when a collision occurs in a selected resource within a subframe of the second communication scheme, the UE transmits in each slot overlapping with the subframe of the second communication scheme.
